(19) United States
(12) Patent Application Publication
(10) Pub. No.: US 2017/0365127 A1
(43) Pub. Date: Dec. 21, 2017

(54) SYMBOL AND REEL MODIFICATION METHODS FOR SLOT MACHINES

(71) Applicant: High 5 Games, LLc, New York, NY (US)

(72) Inventors: A. Stuart Zoble, New York, NY (US); Anthony Singer, New York, NY (US); Daniel Marks, Decatur, GA (US); T. Grant Boiling, Haskell, NJ (US)

(21) Appl. No.: 15/692,100

(22) Filed: Aug. 31, 2017

Related U.S. Application Data
(63) Continuation of application No. 15/144,412, filed on May 2, 2016.
Application No. 15/144,412 is a continuation of application No. 15/144,412, filed on May 2, 2016.
Application No. 15/144,412 is a continuation of application No. 14/703,836, filed on May 4, 2015.
Application No. 14/703,836 is a continuation of application No. 13/432,140, filed on Mar. 28, 2012, now Pat. No. 9,022,852.
Application No. 13/432,140 is a continuation of application No. 12/896,642, filed on Oct. 1, 2010, now abandoned.

(51) Int. Cl. G07F 17/32; G07F 17/34

(52) U.S. Cl. CPC G07F 17/3213; G07F 17/34

(57) ABSTRACT

A gaming system for play of a game, comprising: a display having a display area for play of a game; a credit acceptor to enable input of credit for wagering on the play of the game; and a game controller, said game controller comprising: a first set of symbols, each symbol having a predefined location in said first set relative to others of said symbols; and a second set of symbols; and wherein the game controller is configured to incorporate the second set of symbols prescribed by a schema into the first set by adding the predefined number of said second set of symbols prescribed by the schema into the first set relative to a selected location in said first set so as to define a modified symbol set, to select from the modified symbol set a plurality of symbols for a game outcome, to display in the display area symbols from the modified symbol set for play of the game, and to display a game outcome based on the selected symbols from the modified symbol set.

### CROSS-REFERENCE TO RELATED APPLICATIONS

This application is a continuation of U.S. patent application Ser. No. 15/144,412, now pending, filed on May 2, 2016, which is a continuation of Ser. No. 14/703,836, now pending, filed on May 4, 2015, which is a continuation of Ser. No. 13/432,140, filed Mar. 28, 2012, entitled “Symbol and Reel Substitution Methods for Multi-Line Slot Machines,”, now U.S. Pat. No. 9,022,852m which is a continuation of U.S. patent application Ser. No. 12/896,642, filed Oct. 1, 2010, entitled “Symbol and Reel Substitution Methods for Multi-Line Slot Machines,” the disclosures of which are incorporated by reference herein in their entireties as if fully set forth herein.

### BACKGROUND

### Field of the Invention

Embodiments of the present disclosure generally relate to symbol and reel substitution methods for slot machines. More specifically, embodiments of the present invention generally relate to methods of value-based symbol replacement or modification, whereby new modified reels are created based on schemas, or the like.

### Description of Related Art

To play a conventional slot machine, a player deposits money in the form of coins, gaming tokens or paper currency either into a coin head, a bill acceptor, credit acceptor, or the like. The coins and gaming tokens are collected in a reservoir inside the gaming machine while the paper currency is collected in the bill acceptor inside the gaming machine. A processor validates the coins, gaming token, paper currency, or other form of credit as authentic. Once the processor authenticates the credits, the visual display shows the appropriate number of playing credits on a playing meter. The playing credits may be shown as a monetary amount, a number of spins, or some other multiplier of the monetary value deposited. For example, a twenty-five cent gaming machine will accrue four credits for each dollar that is deposited into the gaming machine.

After accruing credits on the credit meter, the player determines how many credits he wishes to wager on the next spin of the slot reels. After setting the wager, the player spins the reels by pressing the spin button or by pulling a handle. When the reels stop spinning, symbols are displayed on the slot reels. The player then collects credits for winning combinations, if any, according to a pay table. More specifically, the slot machine operates as follows:

Reels and the Symbol Matrix

Slot symbols are located on multiple reels (also called columns) placed adjacent to each other. Reels can either be mechanical reels with fixed symbols located on the reels or an electronic simulation of the mechanical reels whereby the processor generates symbols on positions on the electronic reels. In most embodiments, there are at least three reels in the reel sets.

The visual display includes a visible display area whereby a player can see a portion of the reels. The visual display area (also called a “symbol matrix”) displays a plurality of the reels and a portion of those reels. A typical example is a symbol matrix that displays three to five columns of three adjacent reels. In this typical example, the resulting symbol matrix is a rectangular display of symbols (nine symbols when three columns of three reels are visible and fifteen symbols when five columns of three reels are visible).

Within the symbol matrix, positions on the slot reels may be referred to according to column, from left to right, and row from top to bottom. For example, symbol position 1/2 if located in column 1 (left-most column) and row 2 (second row from the top). In some embodiments, the visible display area may be a non-rectangular shape. For example, the visible display may display one column of the first reel, two columns of the second reel, and one column of the third reel. In this example, four symbol positions would be visible. In some embodiments, only one position on each reel is visible to a player. In some embodiments, multiple reels are vertically aligned and appear to be one column to the player. In some embodiments, only one symbol from each reel is visible (“independent reels”).

The reel strips may be stored in the device's memory as an array of symbol numbers, or similar identifiers, such as ReelStrips[NUMREELS][MAXNUMSTOPS], where NUMREELS is constant, typically five or six, representing the number of reel strips, and MAXNUMSTOPS is the maximum of the number of slots per reel strip. Typically the reel strips have different lengths recorded in an array NumStops[NUMREELS]. Thus Reel Strips [i][j] stores the number of symbol in slot j on reel number i, for every I<NUMREELS and j<NumStops[i].

As an example, consider a slot machine with 3 reel strips having 5, 6 and 7 slots respectively. The array ReelStrips would look like Array 1:

| | |
|---|---|
| 0 | 100 |
| 0 | 103 |
| 0 | 100 |
| 0 | 101 |
| 0 | 102 |
| 1 | 102 |
| 1 | 101 |
| 1 | 103 |
| 1 | 100 |
| 1 | 101 |
| 1 | 102 |
| 2 | 100 |
| 2 | 101 |
| 2 | 102 |
| 2 | 103 |
| 2 | 101 |
| 2 | 101 |
| 2 | 100 |

Where 0 is the first reel strip, 1 is the second reel strip, and 2 is the third reel strip, and 100 represents a certain symbol, for example a bar, 101 represents another symbol, for example a cherry, 102 represents a “7”, 103 represents a bell, and so on. Thus ReelStrips [1][2] would represent a cherry because a cherry is represented by the number 101, and 101 is the number that is found in the array in the position of the second slot of Reel 1.

When a play is initiated, a stop is selected at random for each reel. Then a spinning-reel display is presented to the player. At the end of the play, the spinning ceases with each reel displaying its previously selected stop. The resulting display may be represented as:

$$( \begin{matrix}ReelStrips [ 0 ] [ s [ 0 ] ] & … & ReelStrips [ N - 1 ] [ s [ N - 1 ] ] \\ ⋮ & ⋱ & ⋮ \\ ReelStrips [ 0 ] [ s [ 0 ] + R - 1 ] & … & ReelStrips [ N - 1 ] [ s [ N - 1 ] + R - 1 ]\end{matrix} )$$

Where R represents the number of rows of the display matrix, N=NUMREELS is the number of reels, and s[NUMREELS] is an array into which the randomly-generated stops have been entered (in the displayed matrix, indices of the form s[i]+j are taken modulo NumStops[i], for any i<N and j<R).

Any path through the R×N display matrix consisting of one symbol for each column may be considered a pay line, and customarily some subset of each pay lines is designated in the context of a particular game. To continue with the example, and assuming the display has two rows, at the start of play to following symbols could be randomly generated.

| | | |
|---|---|---|
| 100 | 102 | 103 |
| 101 | 101 | 101 |

When the spinning ceases, the display would be caused to show the symbols corresponding to the symbol numbers above. In this case, the first row would display a bar, a “7”, and a bell, and the second row would display three cherries, or the like. If the second row represented an active play line, and three cherries were defined as a winning combination, then the player would win a prize based on the bottom row of the display.

When the player starts the next play, a new array may be randomly generated and, when the spinning ceased, the corresponding symbols displayed to the player, and so on. Two properties of this type of play are: (a) the set of reel strips does not change, and (b) each reel stop is selected randomly and independently of each other reel stop. These properties limit the possible player experiences. For example, if each reel strip is diversely populated with symbols. If each reel strip contains, for each symbol, stacks of consecutive symbol positions occupied by that symbol, then a typical screen shot involves the occurrences of stacks of different symbols, rather than stacks of the same symbol, across reels.

Players can suffer from boredom by playing games having various different collections of symbol graphics but all using the same game play methods and awards, casinos suffer from the players' boredom and from their inability to distinguish their games offerings from those of other casinos, and game manufacturers suffer from declining orders inasmuch as they are not able to distinguish their product lines from the product lines of other manufacturers.

Some game systems select a first symbol from a symbol set for display in a top row of a column, then select a second symbol from the symbol set for display in the middle row of the same column. The symbol set may be modified between selections. For example, after the first symbol is selected, any like symbols are removed from the symbol set before the second symbol is selected, thereby preventing the same symbol from appearing in two consecutive rows of the same column. In similar fashion, the symbol set may again be modified after selection of the second symbol by removing any like symbol, and then a third symbol is selected for display in the bottom row of the same column. This technique assures each symbol displayed in any one column will differ from all other symbols displayed in the same column.

Some game systems select symbols in each of a plurality of groups of symbols sequentially, and any symbol selected more than once may pay an award. For example, a left-hand column might be selected as a first group and then a middle row might be selected as a second group. One symbol lies at the intersection of these two groups, and since that symbol will have been selected twice, the player may receive an award if that one symbol is a symbol that pays.

In some embodiments, there may be hidden reels whereby none of the reel slots are visible. In some embodiments, the hidden reels become visible after a triggering event. The player collects credits for winning combinations based on the symbols displayed in the visible symbol matrix. In some embodiments, a player may collect additional credits for winning combinations based on symbols in non-visible positions on the reels or on symbols that are on hidden reels.

Winning Combinations.

Players collect credits for predetermined winning symbol combinations that appear in specific positions (pay lines) on the slot reels. Winning combinations typically require that three or more of the same symbols appear adjacent to each other starting from the leftmost position of a pay line (“line pays”). For example, a player may collect a line pay if three banana symbols appeared in symbol positions 1/1, 2/1, and 3/1 on a pay line that includes symbol positions 1/1, 2/1, 3/1, 4/1, and 5/1.

A player may wager on the occurrence of a winning combination on a single pay line or on the occurrence of a winning combination on multiple pay lines. Winning combinations may also occur when three or more of the same symbols appear adjacent to each other starting from the rightmost position of a pay line. Game rules may specify that some symbols may form winning combinations if there are two or more of the same symbol (“majors”) while other symbols may only form winning combinations if there are three or more of the same symbol.

Winning combinations may occur if three or more symbols appear on a pay line regardless of whether they are adjacent or regardless of whether the first occurrence of that symbol is in the leftmost or rightmost column. In some instances, there are wild symbols or substitute symbols that can be matched with other symbols. Players may also collect credits for predetermined winning combinations that appear anywhere on a pay line (“line scatter pays”) or anywhere on the slot reels (“reel scatter pays”). For example, a player may collect a line scatter pay if three banana symbols appeared in symbol positions 1/1, 3/1, and 5/1 on a pay line using symbol positions 1/1, 2/1, 3/1, 4/1, and 5/1; and collect a reel scatter pay if three banana symbols appear anywhere on the visible slot reels.

Pay Table.

Credits are awarded to the player for each winning symbol combination based on a predetermined schedule. For line pays and line scatter pays, the number of credits wagered on the winning pay line multiplies the number of credits indicated by the pay table. For example, a player may wager two credits each on five pay lines, spin the reels, and collect twice the amount indicated on the pay table for a line pay or line scatter pay appearing on any of the five played pay lines. For reel scatter pays, the total number of credits wagered multiplies the number of credits indicated by the pay table. For example, a player may wager ten total credits, spin the reels, and collect ten times the amount indicated on the pay table for a reel scatter pay appearing on anywhere on the slot reels.

Following any type of pay (e.g., line pays, line scatter pays, or reel scatter pays), credits won are added to the player's credit balance shown on the credit meter. As long as the player has credits on the credit meter, the player may continue to play the game. Following any spin, the player may collect the credit balance by pressing a Cash Out button. Credits may be paid out in many different ways. Credits can be paid out as cash or cash alternatives or as credits to play the game.

While the above elements are common to many slot machine games, without more, players are often easily bored by simple conventional game play. Therefore, there remains a need for a slot-machine-type game that provides more excitement and variety.

### SUMMARY

Embodiments of the present disclosure generally relate to symbol and reel substitution methods for slot machines. More specifically, embodiments of the present invention generally relate to methods of value-based symbol replacement, whereby new reels are created based on schemas, or the like.

In one embodiment, a method of operating a slot machine is provided that may comprise providing a slot machine, the slot machine comprising: a reel, the reel including a plurality of symbol positions; a plurality of symbols, at least one of the plurality of symbols located at each of the plurality of symbol positions on the reel, wherein the plurality of symbols comprises a reserved symbol being designated for substitution; a set of symbol replacement schemas, each symbol replacement schema identifying one replacement symbol for replacing the reserved symbol for the reel; and at least one processor for executing instructions stored in a memory to play a slot machine game comprising the steps: receiving a command from a player through an input device and replaying the command to the processor to initiate game play; selecting, by the at least one processor, a symbol replacement schema; replacing the reserved symbol on the reel with a replacement symbol in accordance with the selected symbol replacement schema; displaying a portion of the reels after the replacement on a visual display device; giving an award to the player if a winning combination of symbols appears on the visual display device; and wherein replacing the reserved symbol occurs after, or substantially simultaneously with, receiving the command from the player and before displaying the reel on the visual display device

In another embodiment, a slot machine is provided that may comprise a reel including a plurality of symbol positions; a plurality of symbols, at least one of the plurality of symbols located at each of the plurality of symbol positions on the reel, wherein the plurality of symbols comprise a reserved symbol being designated for substation; a set of symbol replacement schemas, each symbol replacement schema identifying one replacement symbol for replacing the reserved symbol for the reel; and at least one processor for executing instructions on a memory, to provide a game comprising: a command for a player through an input device to initiate game play; a selection, by the at least one processor, of a symbol replacement schema; a replacement of the reserved symbol on the reel with replacement symbols in accordance with the selected symbol replacement schema; a display of a portion of the reel after the replacement on a visual display device; a display of an award to the player on the visual display device if a winning combination of symbols appears on the visual display; and wherein the replacement of the plurality of symbols occurs after, or substantially simultaneously with, the step of receiving the command from the player and before the display of the reel on the visual display device.

In yet another embodiment, a game is provided that may comprise a command from a player through an input device to imitate game play; a reel including a plurality of symbol positions; a plurality of symbols, at least one of the plurality of symbols located at each of the plurality of symbol positions on the reels, wherein the plurality of symbols comprises a reserved symbol being designated for substitution; a selection, by at least one processor, of a symbol replacement schema from a set of symbol replacement schemas, each symbol replacement schema identifying one replacement symbol for replacing the reserved symbol; a display of a portion of the reels comprising the plurality of replacement symbols on a display device; an award to the player if a winning combination of symbols appears on the visual display; and wherein the replacement of the plurality of symbols occurs after, or substantially simultaneously with the command from the player and before the display of the reel on the visual display device.

### BRIEF DESCRIPTION OF THE DRAWINGS

So the manner in which the above recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1A depicts a front perspective view of a gaming device in the form of a slot machine in accordance with one embodiment of the present invention;

FIG. 1B depicts a front perspective view of a gaming device in the form of a slot machine in accordance with another embodiment of the present invention;

FIG. 1C depicts a front perspective view of a gaming device in the form of a mobile device in accordance with one embodiment of the present invention;

FIG. 1D depicts a front perspective view of a gaming device in the form of a personal computer in accordance with one embodiment of the present invention;

FIG. 2A depicts a schematic block diagram of a computer system, which may be used with any of the gaming devices of FIGS. 1A-1D, in accordance with embodiments of the present invention;

FIG. 2B depicts a schematic block diagram illustrating a plurality of gaming terminals and communication with a central controller in accordance with one embodiment of the present invention;

FIG. 3 depicts a symbol key which can be used in connection with a weighted table of symbol replacement schemas in accordance with embodiments of the present invention;

FIG. 4 depicts a weighted table of symbol replacement schemas in accordance with embodiments of the present invention;

FIGS. 5A and 5B depict a game display illustrating an example of one embodiment of the present disclosure wherein symbols are replaced on a single reel;

FIGS. 6A and 6B depict a game display illustrating an example of one embodiment of the present disclosure wherein symbols are replaced on more than one reel;

FIGS. 7A and 7B depict a game display illustrating an example of one embodiment of the present disclosure wherein there are multiple reserved symbols dispersed through the play matrix;

FIG. 8 depicts a symbol key for use in connection with a weighted table of symbol replacement schemas with alternating replacement symbols in accordance with embodiments of the present invention;

FIGS. 9A and 9B depict a game display illustrating an example of one embodiment of the present disclosure wherein reserved symbols are replaced with more than one symbol;

FIGS. 10A and 10B depict a game display illustrating an example of one embodiment of the present disclosure wherein all symbols are replaced on all reels;

FIG. 11 depicts an example of a weighted table of perturbations for use with embodiments of the present invention; and

FIG. 12 depicts a flow chart illustrating an example method in accordance with embodiments of the present disclosure.

### DETAILED DESCRIPTION

In the following detailed description, numerous specific details are set forth in order to provide a thorough understanding of exemplary embodiments or other examples described herein. However, it will be understood that these examples may be practiced without the specific details. In other instances, well-known methods, procedures, and components have not been described in detail, so as to not obscure the following description. Furthermore, the examples disclosed herein are for exemplary purposes only and other examples may be employed in lieu of, or in combination with, the examples disclosed.

Embodiments of the present disclosure generally relate to symbol and reel substitution methods for slot machines. More specifically, embodiments of the present invention generally relate to methods of value-based symbol modification or replacement, whereby new reels are created or modified based on schemas, or the like. Modification as used in this specification refers to symbol insertion/population, deletion, swapping, or the like. It should be appreciated that wherever replace or populate is used, any such modification method can be used.

In accordance with embodiments of the present disclosure, one or more reels may contain regions or “stacks” that will be filled with the same symbol. That is, the new symbols can be selected by a symbol replacement schema to add into a reel to modify the original reels. The symbol substitution may be determined in several steps. In one embodiment, at the time of spinning, a fixed substitution pattern, or “schema,” may be selected from a weighted list of patterns called “schemas.” One or more reels may comprise symbol locations designated for modification or replacement in accordance with the selected schema. In some embodiments, each reel may comprise designated symbols that are replaced according to the schema that is selected. For example, selecting pattern (1, 1, 3, 1, 3) from the weighted list of schemas would indicate that reels 1, 2, and 4 will be filled in with symbol 1 and reels 3 and 5 will have symbol 3 substituted, added in, or the like.

In some embodiments, one or more reel may have a probability of diverting from the pattern via a weighted table, which may be referred to as “perturbations,” or the like. The perturbations table may be dependent upon an initial symbol and reel number. For example, the initial pattern of (2, 1, 2, 1, 1) may call for a substitution of symbol 2 on reel 1. Using the perturbations table, it will be determined whether symbol 2 is used to populate the symbol locations designated for replacement or if an alternate symbol is used. For example, in this example, symbol 2 may have an 80% chance likely to stay the same and a 20% chance of being substituted by an alternative symbol. In one example, maintaining the initial selection of symbol 2 may have an 80% chance, replacing symbol 2 with symbol 3 may have a 15% chance, and replacing symbol 2 with symbol 1 may have a 5% chance, or the like. The perturbations table may include any number of possible replacement symbols and combinations for the symbol selected in accordance with the schema initially chosen. Some exemplary gaming systems in accordance with embodiments of the present disclosure will now be described.

Embodiments of the invention provide for increasing the relative frequency of certain configurations which are desirable and exciting for the player, relative for the frequency of less exciting configurations, while staying within the framework of independently stopped reels, by randomly modifying the reel strips prior to each spin through a family of formally defined substitution methods, or the like including by adding symbols, removing symbols, swapping symbols, or any other such modification method. These new methods admit correlations, across reels, of the occurrence of various symbol combinations, and thus create new varieties of exciting game play not possible in the standard framework.

Briefly and in general terms, a method of operating a slot machine responsive to a command from a player to commence a play includes selecting a symbol schema, replacing symbols on a reel with symbols prescribed by the schema, and presenting a spinning reel display to the player. If a winning combination of symbols appears in a pay line of the slot machine, the player gets an award. The schema may be selected randomly, or according to a weighted probability, or according to a count of recent plays. All symbols of one type may be replaced with one other type of symbol, or with a variety of different symbols as prescribed by the schema. A symbol stack may be replaced with another symbol stack. Symbols may be replaced on one, several, or all of the reels that make up the display.

Embodiments of the invention will now be described in more detail. Consider the array ReelStrips[NUMREELS][MAXNUMSTOPS]. Prior to each play the array may be modified. The most general form of a method in accordance with exemplary embodiments involves a collection of sets of reel strips together with a probability distribution over that collection. More precisely, an array of sets of reel strips may be used, such as ReelStrips[NUMSETS][NUMREELS][MAXNUMSTOPS], with the first coordinate indicating the set number, and NUMSETS as positive integer. IN exemplary embodiments, weights may be associated, or equivalently probabilities, to each set, or simply allow the appropriate number of repetitions in the list and employ a uniform distribution. In this latter setup, a number k<NUMSETS would be randomly drawn prior to each spin, and the set ReelStrips[k][NUMREELS][MAXNUMSTOPS] would be used for that spin in the usual fashion.

In some embodiments, the game may be configured so that set 0 would be twice as likely to appear as set 1. Or the game may be configured with a uniform probability of selecting any one set. In this case, several sets might contain the same arrangements of symbols such that the probability of the player receiving a given arrangement of symbols would depend on how may sets contained that arrangement.

Some embodiments may use special cases of this method, wherein the symbols in certain designated regions on a fixed set of reel strips are randomly changed. By appropriately enumerating every possible changed set of reel strips, this is a special case of the method described above. Such a symbol-substitution method will now be described.

A substitution region may comprise one or more slots or symbol positions on a fixed set of reel strips ReelStrips[NUMREELS][MAXNUMSTOPS] which contain the same fixed symbol number. A substitution pattern, or schema, prescribes for each substitution region a symbol which is to be substituted into every slot of that region. For example, one such schema might substitute the symbol number 100 (representing bar) for every occurrence of the symbol number 101 (representing a cherry).

Such a substitution schema may be presented as array SampleSchema[NUMREELS][NUMSYMBOLS] where NUMSYMBOLS is a number of symbols in a particular game. Every occurrence of symbol j on reel i may be replaced by symbol k.

In some embodiments, a substitution schema is applied by creating a duplicate set of reels as a temporary set of reels. The substitution schema is then applied to the temporary set of reels. Similarly, a substitution schema can be applied by populating the symbols in the symbol positions of the temporary set of reels by analyzing whether each symbol should be directly copied or whether analysis according to a substitution schema must occur.

A probability distribution of schemas may be represented as an array Schemas [NUMSCHEMAS][NUMREELS][NUMSYMBOLS] where NUMSCHEMAS is the number of schemas. The schemas array is a list of schemas, with possible repetitions. Prior to each spin, a schema may be randomly selected with uniform probability form the array, and the reel strips are modified according to the selected schema, and the modified reel strips are spun as usual. Some embodiments use a subset of symbols numbers as regions.

In some embodiments, a perturbation table is further used to further manipulate the reels. Such a perturbation table may be an array Perturb[NUMREELS][NUMSYMBOLS][NUMSYMBOLS] of weights. Using such a perturbation table, the actual substitution of symbols may occur in multiple steps. First a schema may be randomly selected. Next, for every i<NUMREELS and j<NUMSYMBOLS a symbol number 1 is randomly drawn using the weights perturb[i][Schemas[k][i][j][1]; for 1<NUMSYMBOLS. This symbol number 1, rather than the number Schemas[k][i][j] initially prescribed by schema k, is substituted for every occurrence of symbol number j on reel i. These random draws are independent of one another. In some embodiments the same distribution can be achieved without this service by suitably enlarging the list of schemas. In other embodiments a relatively small list of interesting schemas is identified and variety is added through these random perturbations.

In some embodiments that use a perturbation table, a selected perturbation modifies a selected schema. In these embodiments, for each reel number i and each symbol number j the substitution symbol Schemas[schema_num][i][j] is randomly changed according to the perturbation. Probabilities derived from the array Perturb, and the value is recorded. Then the required substitutions are performed, and the modified reel strips are recorded in the array. For a slot machine game, the schemas and perturb arrays may be supplied as a text file, in addition to the reel strips, pay table, and other parameters of the game.

One embodiment, nicknamed “Super Stacks”, involves using the substitution method described above to create stacks of consecutive positions occupied by the same symbol. The simplest version of a Super Stack game involves a reserved symbol, say symbol number 0, which can be blank symbols, symbols that are never displayed to a player, or some other type of symbol, and a set of reel strips ReelStrips[NUMREELS][MAXNUMSTOPS] containing, on each reel, sequences of consecutive positions occupied by this blank symbol. Slots containing this symbol are considered as the only substitution region on each reel. If it is assumed, for example, that NUMREELS=5, the schemas array reduces to sequence of 5-vectors of symbol numbers. For example, one such schema: (6,6,6,8,8) might call for substituting an “Ace” in all blanks on the first 3 reels and a “Jack” in all blanks on the last two. Prior to each spin, a schema is randomly selected from the list, the required substitutions are performed, and the resulting reel stripes are spun. It should be appreciated that the reserved symbols can be thought of as placeholder designations such that symbols indicated by a selected schema are inserted into the reel at the placeholder designations. In this regard, a series of reserved symbols in a row indicate a number of

In other embodiments perturbations may be used, and there may be more than one reserved symbol. In another embodiment, the substitution method is used to improve an existing game. In the notion set forth above, an identity schema prescribes that every occurrence of symbol j on reel i be replaced by the same symbol j. If such a schema is selected, the original reel strips are left unchanged if there are no perturbations. Such as schema could be used a relatively large percentage of the time, and different schemas the remainder of the time, thus achieving a modest enhancement of the original game. Alternatively, schemas that involve many substitutions for only a few symbols could be used often, thereby achieving a more radical departure from the original game.

Another embodiment may start with two or more sets of reels as in the summary above. These may be represented by an array: ReelStrips[NUMSETS][NUMREELS][MAXNUMSTOPS] where NUMSETS≧2. An array of schemas of the form Schema [NUMSCHEMA][NUMREELS]; may also be used. Each element of the array Schema may be the index of a reel set. Prior to each spin, a number k<NUMSCHEMAS is randomly selected, and a set of reels is assembled as follows. For i<NUMREELS, reel i from reel set schema[k][i] is used. In other words, slot j on reel i is occupied by symbol ReelStrips[Schema[k][i]][i][j]]. For example, suppose NUMSET=2, and the reel strips of set of number 0 each contain stacks of wild symbols, while the reel strips of set 1 do not. Then for each k<NUMSETS, schema number k is naturally viewed as a five-vector of binary digits. The schema (0,0,0,1,1) would call for the use of the reel strips from the set containing the stack of wild symbols on the first three reels, and for the use of the reel strips without stacks for the last two reels.

In some embodiments the various schemas and symbol substitutions may be computed in advance of play or on-the-fly at the start of each play in the slot machine. Or the computations may be carried out ahead of time in a separate computer system (not shown) and included in the instructions or loaded into memory or communicated to the processor in some other way such as over a communications link.

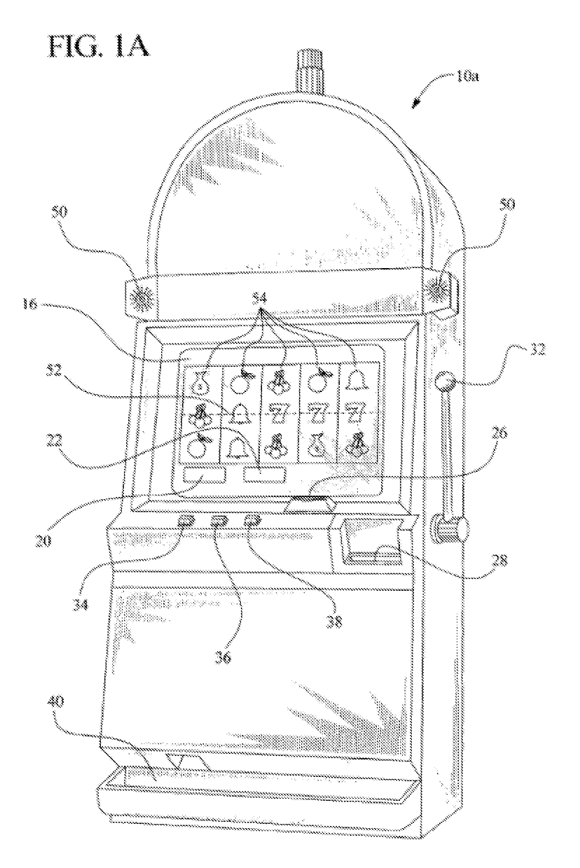

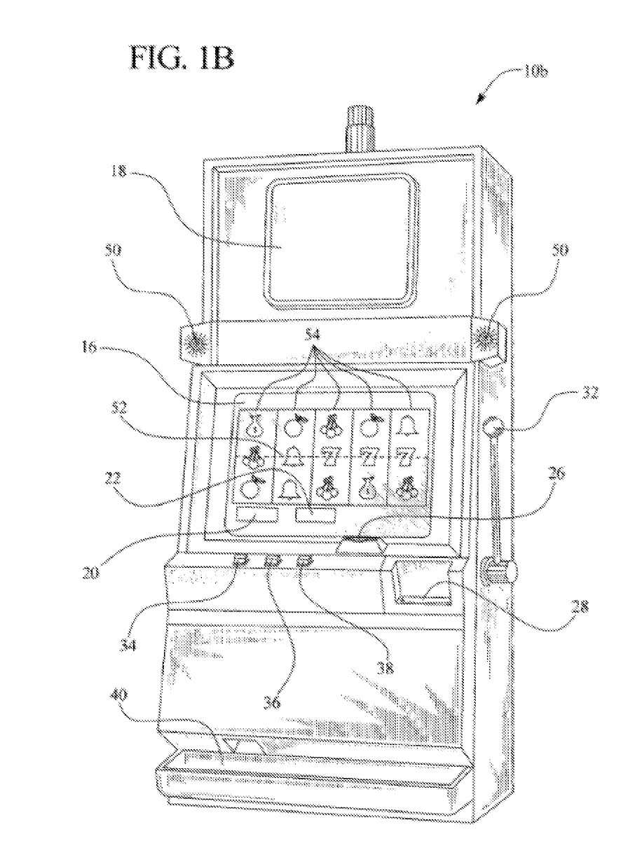

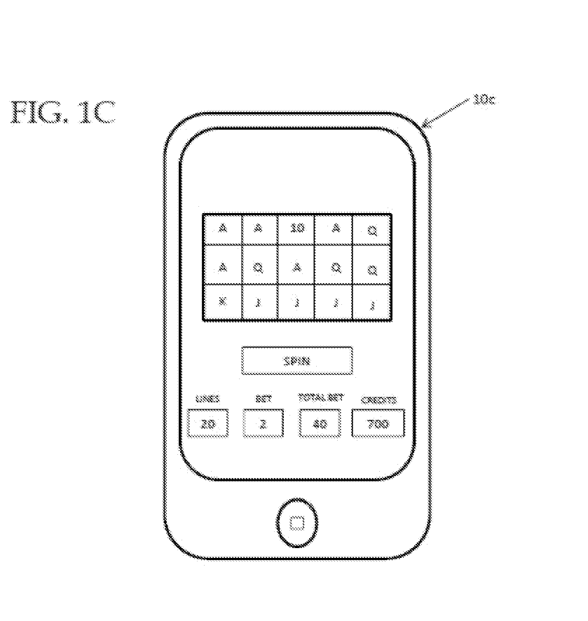

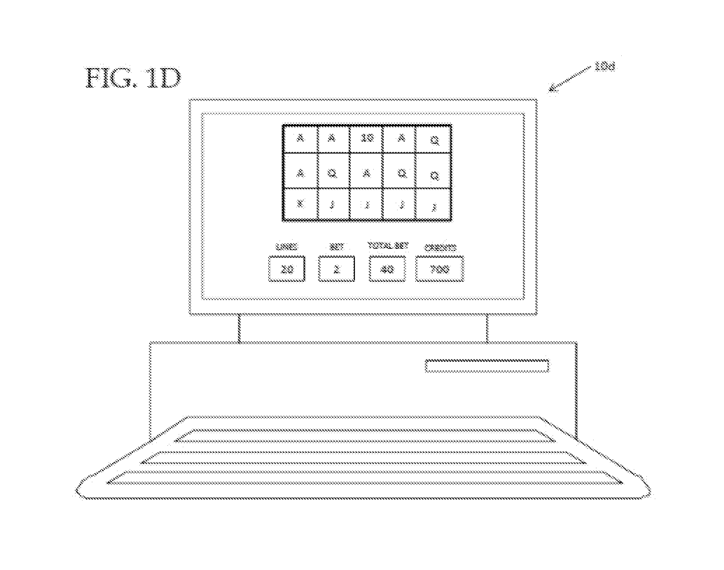

Two alternative embodiments of the gaming device of the present invention are illustrated in FIGS. 1A and 1B as gaming device 10a and gaming device 10b, respectively. Gaming device 10a and/or gaming device 10b are generally referred to herein as gaming device 10.

In one embodiment, as illustrated in FIGS. 1A and 1B, gaming device 10 has a support structure, housing or cabinet which provides support for a plurality of displays, inputs, controls and other features of a conventional gaming machine. It is configured so that a player can operate it while standing or sitting. The gaming device may be positioned on a base or stand or can be configured as a pub-style table-top game (not shown) which a player can operate preferably while sitting. As illustrated by the different configurations shown in FIGS. 1A and 1B, the gaming device can be constructed with varying cabinet and display configurations.

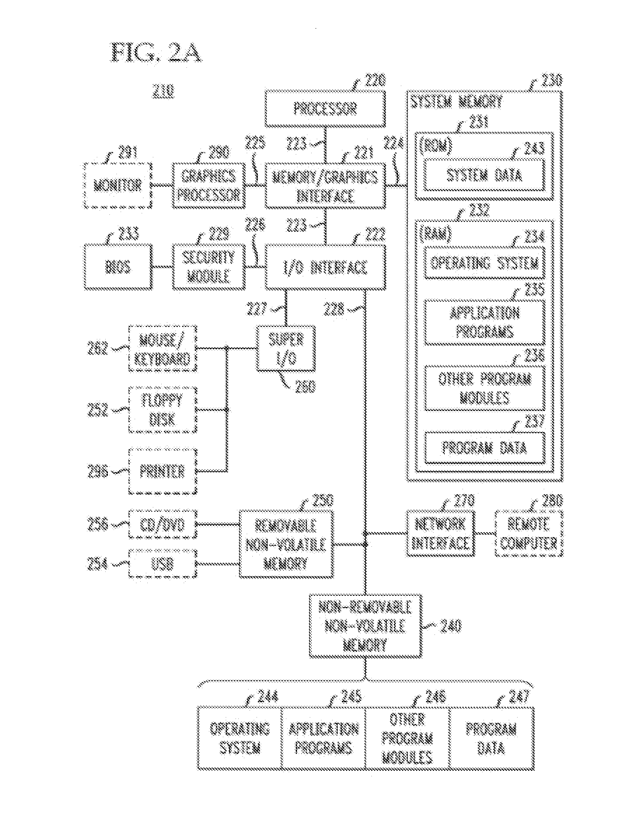

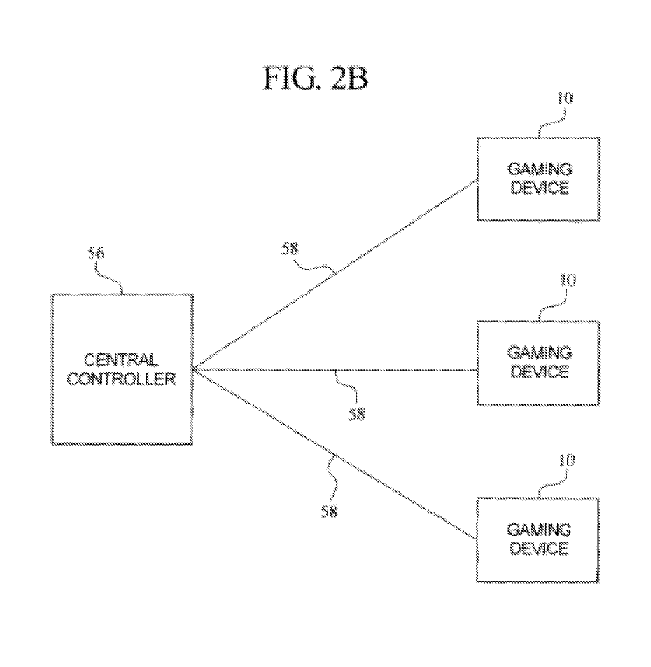

In several embodiments, the electronic gaming devices, for example, as shown in FIGS. 1A-1D, may comprise all or part of a computer system, for example, the computer system of FIG. 2. It should be appreciated, however, the computing system of FIG. 2 is merely an exemplary embodiment of an electronic device, and actual electronic devices may comprise any one or more components shown in FIG. 2A, suitable for embodiments of the present invention.

With reference to FIG. 2A, a computer system in the form of a computer 210 is shown. As understood by embodiments of the present invention, components shown in dashed outline are not part of the computer 210, but are used to illustrate the exemplary embodiment of FIG. 2A. Components of computer 210 may include, but are not limited to, a processor 220, a system memory 230, a memory/graphics interface 221, also known as a Northbridge chip, and an I/O interface 222, also known as a Southbridge chip. The system memory 230 and a graphics processor 290 may be coupled to the memory/graphics interface 221. A monitor 291 or other graphic output device may be coupled to the graphics processor 290.

A series of system busses may couple various system components including a high speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hyper transport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and can accessed by the computer 210.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. The system ROM 231 may contain permanent system data 243, such as identifying and manufacturing information. In some embodiments, a basic input/output system (BIOS) may also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237.

The I/O interface 222 may couple the system bus 223 with a number of other buses 226, 227 and 228 that couple a variety of internal and external devices to the computer 210. A serial peripheral interface (SPI) bus 226 may connect to a BIOS memory 233 containing the basic routines that help to transfer information between elements within computer 210, such as during start-up.

In some embodiments, a security module 229 may be incorporated to manage receipt of money/credits, issuance of money/credits, and enforcement of policies, as may be required in the gaming industry. In many embodiments, such security module 229 may be coupled with a payment acceptor built into a physical machine. A payment acceptor may include a coin slot and a payment, note or bill acceptor, where the player inserts money, coins or tokens. For example, the player can place coins in the coin slot or paper money, ticket or voucher into the payment, note or bill acceptor. In other embodiments, devices such as readers or validators for credit cards, debit cards or credit slips could be used for accepting payment. In one embodiment, a player may insert an identification card into a card reader of the gaming device. In one embodiment, the identification card is a smart card having a programmed microchip or a magnetic strip coded with a player's identification, credit totals and other relevant information. In one embodiment, money may be transferred to a gaming device through electronic funds transfer. When a player funds the gaming device, the processor determines the amount of funds entered and the corresponding amount is shown on the credit or other suitable display as described above.

A super input/output chip 260 may be used to connect to a number of ‘legacy’ peripherals, such as floppy disk 252, keyboard/mouse/buttons 262, and printer 296, as examples. The super I/O chip 260 may be connected to the I/O interface 222 with a low pin count (LPC) bus, in some embodiments. The super I/O chip 260 is widely available in the commercial marketplace.

In one embodiment, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The computer 210 may also include other removable/non-removable, volatile/nonvolatile computer storage media. By way of example only, FIG. 2A illustrates a hard disk drive 240 that reads from or writes to non-removable, nonvolatile magnetic media. Removable media, such as a universal serial bus (USB) memory 252 or CD/DVD drive 256 may be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media, discussed above and illustrated in FIG. 2A, provide storage of computer readable instructions, data structures, program modules and other data for the computer 210. In FIG. 2A, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum; they are different elements within the computer 210. A user may enter commands and information into the computer 210 through input devices such as a mouse/keyboard 262 or other input device combination. Other input devices (not shown) may include a microphone, joystick, game pad, satellite dish, scanner, or the like. These and other input devices are often connected to the processor 220 through one of the I/O interface busses, such as the SPI 226, the LPC 227, or the PCI 228, but other busses may be used. In some embodiments, other devices may be coupled to parallel ports, infrared interfaces, game ports, and the like (not depicted), via the super I/O chip 260.

The computer 210 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the computer 210. The logical connection between the NIC 270 and the remote computer 280 depicted in FIG. 2 may include a local area network (LAN), an Ethernet-based network, a wide area network (WAN), or both, but may also include other networks. Such networking environments are commonplace in offices, enterprise-wide computer networks, intranets, and the Internet.

Returning to FIGS. 1A-1D, in one embodiment, as discussed in more detail below, the gaming device randomly generates awards and/or other game outcomes based on probability data. That is, each award or other game outcome is associated with a probability and the gaming device generates the award or other game outcome to be provided to the player based on the associated probabilities. In this embodiment, since the gaming device generates outcomes randomly or based upon a probability calculation, there is no certainty that the gaming device will ever provide the player with any specific award or other game outcome.

In another embodiment, as discussed in more detail below, the gaming device employs a predetermined or finite set or pool of awards or other game outcomes. In this embodiment, as each award or other game outcome is provided to the player, the gaming device removes the provided award or other game outcome from the predetermined set or pool. Once removed from the set or pool, the specific provided award or other game outcome cannot be provided to the player again. This type of gaming device provides players with all of the available awards or other game outcomes over the course of the play cycle and guarantees the amount of actual wins and losses.

As shown by FIGS. 1A and 1B, and supported by the elements depicted in FIG. 2A, many embodiments of the present invention comprise at least one, and often a plurality, of input devices in communication with the processor. The input devices can include any suitable device which enables the player to produce an input signal which is read by the processor, for instructing the game and/or gaming device to do something. In one embodiment, after appropriate funding of the gaming device, the input device is a game activation device, such as a pull arm 32 or a play button 34 which is used by the player to start any primary game or sequence of events in the gaming device. The play button can be any suitable play activator such as a bet one button, a max bet button or a repeat the bet button. In one embodiment, upon appropriate funding, the gaming device begins the game play automatically. In another embodiment, upon the player engaging one of the play buttons, the gaming device automatically activates game play.

In one embodiment, as shown in FIGS. 1A and 1B, one input device is a bet one button 36. The player places a bet by pushing the bet one button. The player can increase the bet by one credit each time the player pushes the bet one button. When the player pushes the bet one button, the number of credits shown in the credit display preferably decreases by one, and the number of credits shown in the bet display preferably increases by one. In another embodiment, one input device is a bet max button (not shown) which enables the player to bet the maximum wager permitted for a game of the gaming device.

In one embodiment, one input device is a cash-out button 38. The player may push the cash out button and cash out to receive a cash payment or other suitable form of payment corresponding to the number of remaining credits. In one embodiment, when the player cashes out, the player receives the coins or tokens in a coin payout tray 40. In one embodiment, when the player cashes out, the player may receive other payout mechanisms such as tickets or credit slips redeemable by a cashier or funding to the player's electronically recordable identification card.

In one embodiment, one input device is a touch-screen coupled with a touch-screen controller, or some other touch-sensitive display overlay to allow for player interaction with the images on the display. The touch-screen and the touch-screen controller are connected to a video controller. A player can make decisions and input signals into the gaming device by touching touch-screen at the appropriate places.

In one embodiment, the gaming device includes a sound generating device controlled by one or more sound cards which function in conjunction with the processor. In one embodiment, the sound generating device includes at least one and preferably a plurality of speakers or other sound generating hardware and/or software for generating sounds, such as playing music for the primary and/or secondary game or for other modes of the gaming device, such as an attract mode. In one embodiment, the gaming device provides dynamic sounds coupled with attractive multimedia images displayed on one or more of the display devices to provide an audio-visual representation or to otherwise display full-motion video with sound to attract players to the gaming device. During idle periods, the gaming device may display a sequence of audio and/or visual attraction messages to attract potential players to the gaming device. The videos may also be customized for or to provide any appropriate information.

In one embodiment, the gaming machine may include a player or other sensor, such as a camera in communication with the processor (and possibly controlled by the processor) that is selectively positioned to acquire an image of a player actively using the gaming device and/or the surrounding area of the gaming device. In one embodiment, the camera may be configured to selectively acquire still or moving (e.g., video) images and may be configured to acquire the images in either an analog, digital or other suitable format. The display devices may be configured to display the image acquired by the camera as well as display the visible manifestation of the game in split screen or picture-in-picture fashion. For example, the camera may acquire an image of the player and that image can be incorporated into the primary and/or secondary game as a game image, symbol or indicia.

Suitable gaming devices may incorporate any suitable wagering primary or base game. The gaming machine or device of embodiments of the present invention may include some or all of the features of conventional gaming machines or devices. The primary or base game may comprise any suitable reel-type game, card game, number game or other game of chance susceptible to representation in an electronic or electromechanical form which produces a random outcome based on probability data upon activation from a wager. That is, different primary wagering games, such as video poker games, video blackjack games, video Keno, video bingo or any other suitable primary or base game may be implemented into an embodiment of the present invention.

In one embodiment, a base or primary game may be a slot game with one or more pay lines 52. The pay lines may be horizontal, vertical, circular, diagonal, angled or any combination thereof. In this embodiment, the gaming device displays at least one and preferably a plurality of reels 54, for example, having three to five reels 54 in either electromechanical form with mechanical rotating reels or video form with simulated reels and movement thereof. In one embodiment, an electromechanical slot machine includes a plurality of adjacent, rotatable wheels which may be combined and operably coupled with an electronic display of any suitable type. In another embodiment, if the reels 54 are in video form, the plurality of simulated video reels 54 are displayed on one or more of the display devices as described above. Each reel 54 displays a plurality of indicia such as bells, hearts, fruits, numbers, letters, bars or other images which may generally correspond to a theme associated with the gaming device. In this embodiment, the gaming device awards prizes when the reels of the primary game stop spinning if specified types and/or configurations of indicia or symbols occur on an active pay line or otherwise occur in a winning pattern.

In one embodiment, in addition to winning credits in a base or primary game, the gaming device may also give players the opportunity to win credits in a bonus or secondary game or bonus or secondary round. The bonus or secondary game enables the player to obtain a prize or payout in addition to the prize or payout, if any, obtained from the base or primary game. In general, a bonus or secondary game produces a significantly higher level of player excitement than the base or primary game because it provides a greater expectation of winning than the base or primary game and is accompanied with more attractive or unusual features than the base or primary game.

In one embodiment, the bonus or secondary game may be any type of suitable game, either similar to or completely different from the base or primary game. In one embodiment, the gaming device includes a program which will automatically begin a bonus round when the player has achieved a triggering event or qualifying condition in the base or primary game. In one embodiment, the triggering event or qualifying condition may be a selected outcome in the primary game or a particular arrangement of one or more indicia on a display device in the primary game, such as the number seven appearing on three adjacent reels along a pay line in the primary slot game embodiment seen in FIGS. 1A and 1B. In another embodiment, the triggering event or qualifying condition may be by exceeding a certain amount of game play (number of games, number of credits, amount of time), reaching a specified number of points earned during game play or as a random award.

In one embodiment, once a player has qualified for a bonus game, the player may subsequently enhance his/her bonus game participation through continued play on the base or primary game. Thus, for each bonus qualifying event, such as a bonus symbol, that the player obtains, a given number of bonus game wagering points or credits may be accumulated in a “bonus meter” programmed to accrue the bonus wagering credits or entries toward eventual participation in a bonus game. The occurrence of multiple such bonus qualifying events in the primary game may result in an arithmetic or geometric increase in the number of bonus wagering credits awarded. In one embodiment, extra bonus wagering credits may be redeemed during the bonus game to extend play of the bonus game.

In one embodiment, no separate entry fee or buy in for a bonus game need be employed. That is, a player may not purchase an entry into a bonus game; he must win or earn entry through play of the primary game and, thus, play of the primary game is encouraged. In another embodiment, qualification of the bonus or secondary game could be accomplished through a simple “buy in” by the player if, for example, the player has been unsuccessful at qualifying through other specified activities.

In one embodiment, as illustrated in FIG. 2B, one or more of the gaming devices 10 of embodiments of the present invention may be connected to each other through a data network or a remote communication link 58 with some or all of the functions of each gaming device provided at a central location such as a central server or central controller 56. More specifically, the processor of each gaming device may be designed to facilitate transmission of signals between the individual gaming device and the central server or controller.

In one embodiment, the game outcome provided to the player is determined by a central server or controller and provided to the player at the gaming device of an embodiment of the present invention. In this embodiment, each of a plurality of such gaming devices is in communication with the central server or controller. Upon a player initiating game play at one of the gaming devices, the initiated gaming device communicates a game outcome request to the central server or controller.

In one embodiment, the central server or controller receives the game outcome request and randomly generates a game outcome for the primary game based on probability data. In another embodiment, the central server or controller randomly generates a game outcome for the secondary game based on probability data. In another embodiment, the central server or controller randomly generates a game outcome for both the primary game and the secondary game based on probability data. In this embodiment, the central server or controller is capable of storing and utilizing program code or other data similar to the processor and memory device of the gaming device.

In an alternative embodiment, the central server or controller maintains one or more predetermined pools or sets of predetermined game outcomes. In this embodiment, the central server or controller receives the game outcome request and independently selects a predetermined game outcome from a set or pool of game outcomes. The central server or controller flags or marks the selected game outcome as used. Once a game outcome is flagged as used, it is prevented from further selection from the set or pool and cannot be selected by the central controller or server upon another wager. The provided game outcome can include a primary game outcome, a secondary game outcome, primary and secondary game outcomes, or a series of game outcomes such as free games.

The central server or controller communicates the generated or selected game outcome to the initiated gaming device. The gaming device receives the generated or selected game outcome and provides the game outcome to the player. In an alternative embodiment, how the generated or selected game outcome is to be presented or displayed to the player, such as a reel symbol combination of a slot machine or a hand of cards dealt in a card game, is also determined by the central server or controller and communicated to the initiated gaming device to be presented or displayed to the player. Central production or control can assist a gaming establishment or other entity in maintaining appropriate records, controlling gaming, reducing and preventing cheating or electronic or other errors, reducing or eliminating win-loss volatility and the like.

In another embodiment, one or more of the gaming devices are in communication with a central server or controller for monitoring purposes only. That is, each individual gaming device randomly generates the game outcomes to be provided to the player and the central server or controller monitors the activities and events occurring on the plurality of gaming devices. In one embodiment, the gaming network includes a real-time or on-line accounting and gaming information system operably coupled to the central server or controller. The accounting and gaming information system of this embodiment includes a player database for storing player profiles, a player tracking module for tracking players and a credit system for providing automated casino transactions.

A plurality of the gaming devices are capable of being connected together through a data network. In one embodiment, the data network is a local area network (LAN), in which one or more of the gaming devices are substantially proximate to each other and an on-site central server or controller as in, for example, a gaming establishment or a portion of a gaming establishment. In another embodiment, the data network is a wide area network (WAN) in which one or more of the gaming devices are in communication with at least one off-site central server or controller. In this embodiment, the plurality of gaming devices may be located in a different part of the gaming establishment or within a different gaming establishment than the off-site central server or controller. Thus, the WAN may include an off-site central server or controller and an off-site gaming device located within gaming establishments in the same geographic area, such as a city or state. The WAN gaming system may be substantially identical to the LAN gaming system described above, although the number of gaming devices in each system may vary relative to each other.

In another embodiment, the data network is a global computer network, such as the Internet, or an intranet network, and the gaming system may be considered an online system, a mobile system, or the like. In this embodiment, the operation of the gaming device can be viewed at the gaming device with at least one web browser, or application, such that access to the data network is feasible. In this embodiment, operation of the gaming device and accumulation of credits may be accomplished with a connection to the central server or controller through a conventional phone or other data transmission line, digital signal line (DSL), T-1 line, coaxial cable, fiber optic cable, or other suitable connection. In this embodiment, players may access a game page from any location where a network connection and computer, or other gaming device 10, are available. For example, either of the gaming devices of FIGS. 1C and 1D are suitable for accessing such a data network.

In one embodiment a plurality of paylines may be associated with the reels. In one embodiment, the gaming device provides an outcome to the player when a designated combination of symbols such as a winning combination of symbols is indicated in at least one symbol position on one of the paylines. In another embodiment, the gaming device provides the outcome to the player when the winning symbol combination is indicated in at least one symbol position on a plurality of the paylines. In a further embodiment, the gaming device provides the outcome to the player when a winning symbol combination is indicated in at least one symbol position on any of the paylines associated with the reels. It should be appreciated that a designated combination of symbols or a winning symbol combination may be a line pay, a line scatter pay, a reel scatter pay or any suitable winning combination of the symbols.

In one embodiment, the gaming device includes a set of meters or displays used to display the relative information for the game, including the number of credits, number of pay lines, amount bet per line, total bet, and the amount paid to the player in a spin of the reels. If necessary, any number of meters may be added to further facilitate control of the games.

In another embodiment, the number of credits in the credit pool is displayed by a credit meter or credit display. The pool of credits increases and decreases according to the player's wins or losses in a game and may be supplemented, if necessary, by the player when the player deposits additional coins, tokens or paper currency into the gaming device.

In yet another embodiment, the number of pay lines upon which the player wagered in a game is displayed on a Number of Pay Lines meter or display. The pay lines are activated in a predetermined order, as follows: the first wager is applied to a pay line; the second wager is applied to a second pay line; and the third wager is applied to a third pay line. However, the games may have fewer or greater than three pay lines and activate the paylines in any suitable order. In a further embodiment, the number of credits wagered on each pay line is displayed on a Bet Per Line display. In this embodiment, the same amount is wagered on each of the pay lines. Alternatively, in another embodiment the player could wager different amounts on each pay line in a game.

In one embodiment, the total number of credits bet on all of the pay lines may be displayed by a Total Bet display. The total bet is calculated by multiplying the number of pay lines by the bet per line. In addition, the number of credits awarded for any winning symbol combinations may be displayed by a Paid display.

A slot machine in which the methods disclosed herein may be used typically includes a processor, a video display that shows spinning reels, a start control, and instructions that cause the processor to select a symbol schema, replace a plurality of symbols that make up a reel with symbols prescribed by the selected schema, depict spinning reels on the display, and if a winning combination of symbols appears in a pay line, give an award to the player.

Winning combinations may be defined by pay tables or award summary tables associated with a game. The pay tables define the winning symbol combinations for a game such as a winning symbol combination including three or more of the same symbols on a pay line. Each symbol in a symbol position counts towards the total number of symbols on a pay line. In addition, a pay table may also define scatter awards for winning symbol combinations including symbols scattered anywhere on the reels. Alternatively, any pre-determined or designated arrangement of symbols may be defined as a winning symbol combination in a game and any suitable number of awards or credits may be provided to a player for the winning symbol combinations.

A payout table or award summary table indicates the winning symbol combinations and the awards or credits associated with each of those winning symbol combinations. The award summary table includes winning symbol combinations for the symbols and the awards associated with those symbols. It should be appreciated that the designated symbol combinations or winning symbol combinations in the game may include any suitable combination of the same symbols or different symbols in the game. In addition, it should be appreciated that the winning symbol combinations may provide any suitable awards, prizes, free games, free spins, game elements or any other suitable award, awards or outcomes in the game.

To operate and play the game, a player initially inserts currency into the game and obtains a number of credits as indicated by a credit display. The player begins playing the game by depressing the select paylines button to increase the number of paylines wagered in the game from one to three as indicated by a number of paylines display.

Next, the player may press the bet per payline button to increase their bet or wager on each payline from one to three credits as indicated by the bet per payline display. Therefore, the player may wager three credits on each of the paylines. Based on the wager made by the player in this spin or activation of the reels in the game, a total bet or wager is indicated by a total bet display. The total bet equals the number of paylines wagered on by the player of three multiplied by the amount bet per payline by the player. Because the game has not started yet the pay display may indicate a zero or that the player has not received any awards or credits in the game. The total bet made by the player in an activation or spin of the reels is subtracted from the player's total credits in the game which results in the new total number of credits being indicated by a credit display.

The gaming device or player presses or activates a play button or pull arm 32 (shown in FIGS. 1A and 1B) to activate or spin the reels for the first time in the game. The reels stop and display a plurality of symbols in the symbol positions on the reels 54. Specifically, the reels or symbol matrix on the reels includes a winning symbol combination at the symbol positions on paylines associated with reels 54.

The expansion in the number of computers and number and speed of internet connections in recent years increases opportunities for players to play from an ever-increasing number of remote sites. It should be appreciated that enhanced bandwidth of digital wireless communications may render such technology suitable for some or all communications according to some embodiments of the present invention, particularly if such communications are encrypted. Higher data transmission speeds may be useful for enhancing the sophistication and response of the display and interaction with the player.

In another embodiment, a plurality of gaming devices at one or more gaming sites may be networked to a central server in a progressive configuration, wherein a portion of each wager to initiate a base or primary game may be allocated to bonus or secondary event awards. In one embodiment, a host site computer is coupled to a plurality of the central servers at a variety of mutually remote gaming sites for providing a multi-site linked progressive automated gaming system. In one embodiment, a host site computer may serve gaming devices distributed throughout a number of properties at different geographical locations including, for example, different locations within a city or different cities within a state.

In one embodiment, the host site computer is maintained for the overall operation and control of the system. In this embodiment, a host site computer oversees the entire progressive gaming system and is the master for computing all progressive jackpots. All participating gaming sites report to, and receive information from, the host site computer. Each central server computer is responsible for all data communication between the gaming device hardware and software and the host site computer.

In some embodiments, the data network may be integrated into an existing network platform, for example, a social networking site. For example, in one embodiment, the data network may comprise an application within a social networking site, e.g., Facebook, whereby players may access the data network via a connection to the social networking site. Such an integrated arrangement may be advantageous for applications of embodiments of the present invention that seek to have near immediate access to a significant potential customer base.

In further embodiments, the data network may be accessed via a downloadable application to a mobile device, such as a smartphone, a tablet, a mobile computer, or the like. As is known in the mobile device industry, such a downloadable application may be stored at a remote server, and upon request, a player may utilize a mobile device to download such downloadable application to be stored locally on the mobile device. Such downloadable application may access the data network through the mobile device's network connection, and provide the player a convenient means through which to access the data network. In alternative embodiments, the downloadable application may not require a network connection on a regular basis, and a game may be accessible locally on the mobile device. However, in such embodiments, some of the benefits of networked game play, such as competitions, updates, etc., may not be available until the mobile device reconnects to the data network.

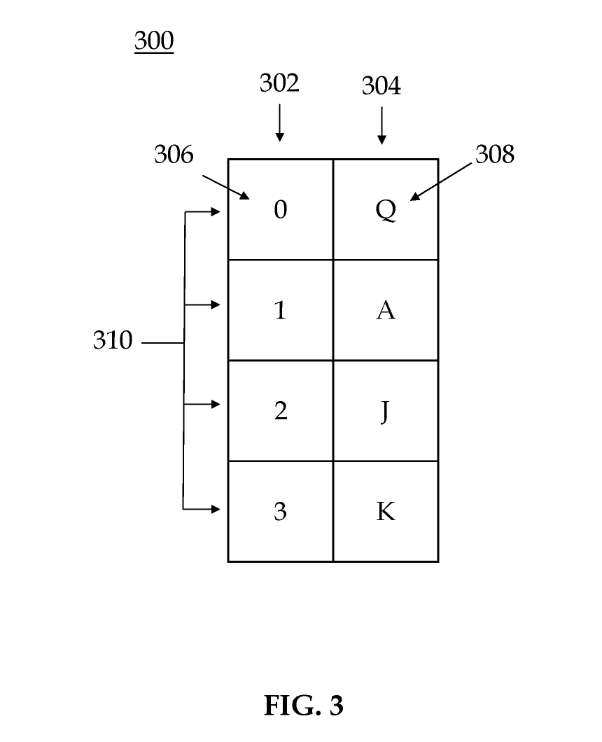

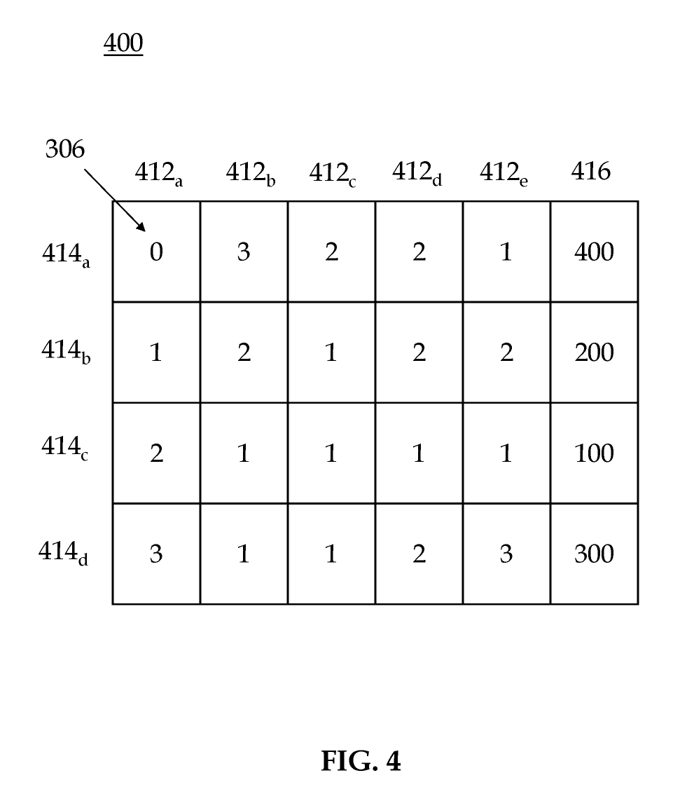

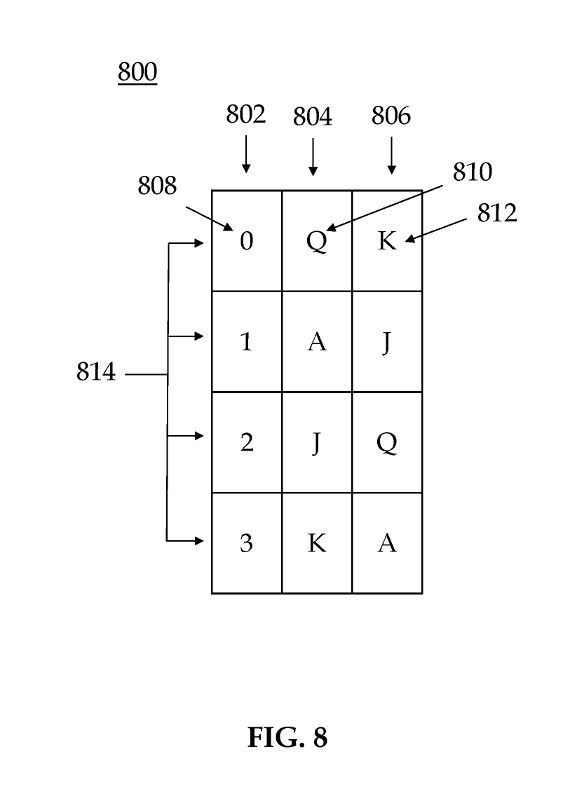

Referring now to FIG. 3, a symbol key 300 can be used in some embodiments in connection with a weighted table of symbol modification or replacement schemas in accordance with embodiments of the present disclosure is depicted. The symbol key 300 is shown with replacement indicators 306 in a first column 302. For ease, only four replacement indicators 306 are shown, but any number of replacement indicators 306 suitable for embodiments of the present disclosure are contemplated. Generally, a replacement indicator 306 may be associated with one or more replacement symbols 304, shown in a second column 304 in FIG. 3. The rows 310 of the symbol key 300 indicate the relationship between a particular replacement indicator 306 and a replacement symbol 308. In the example depicted in FIG. 3, the replacement indicators 0, 1, 2, 3 correspond to replacement symbols Q, A, J, K, respectively. In some embodiments, one or more replacement indicators 306 may correspond to more than one replacement symbol 304. One example of this is illustrated by the table shown in FIG. 8. Replacement indicators 306 may be disbursed on a weighted table of schemas, as shown in FIG. 4.

FIG. 4 depicts a weighted table of symbol replacement schemas 400 in accordance with embodiments of the present invention. The weighted table 400 may comprise rows of schemas, such as schemas 414ₐ, 414_{b}, 414_{c}, and 414_{d}, or the like. The schemas may include a number of replacement indicators 306 that correspond to one or more replacement symbols, for example, as illustrated in FIG. 3. The table 400 may comprise any number of columns and rows suitable for embodiments of the present disclosure. In some embodiments, the replacement indictors 306 may correspond to each reel present in a particular game. For example columns 412ₐ, 412_{b}, 412_{c}, 412_{d}, and 412ₑ, may correspond to reels 1, 2, 3, 4, and 5 of a game, respectively. Each of the schemas 414ₐ, 414_{b}, 414_{c}, and 414_{d}, may be assigned a weight or probability, as indicated by the weight column 416. In the example depicted in FIG. 4, each schema is assigned a weight. By way of example, schema 414ₐ, with a weight of 400, may be approximately twice as likely to be selected by the game as schema 414_{b}, with a weight of 200, and the like. In one embodiment of the present disclosure, one or more reels may be assigned certain symbol locations designated for replacement. The symbol locations designated for replacement on the one or more reels may be associated with a particular column of the weighted table 400. By way of example, column 412ₐ may be associated with reel 1 of a game, column 412_{b} may be associated with reel 2 of a game, and so on.

In some other embodiments, columns 412a, 412b, 412c, 412d, and 412e may correspond to particular reserved symbols. By way of example, 412a may correspond to an “R1” reserved symbol, 412b may correspond to an “R2” reserved symbol, 412c may correspond to an “R3” reserved symbol, 412d may correspond to an “R4” reserved symbol, and 412d may correspond to an “R5” reserved symbol.

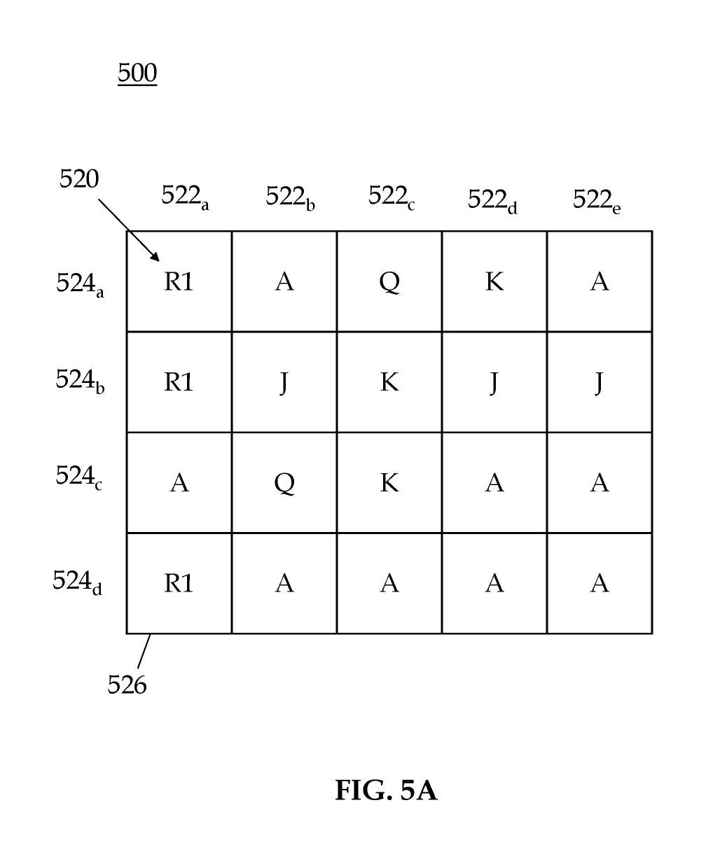

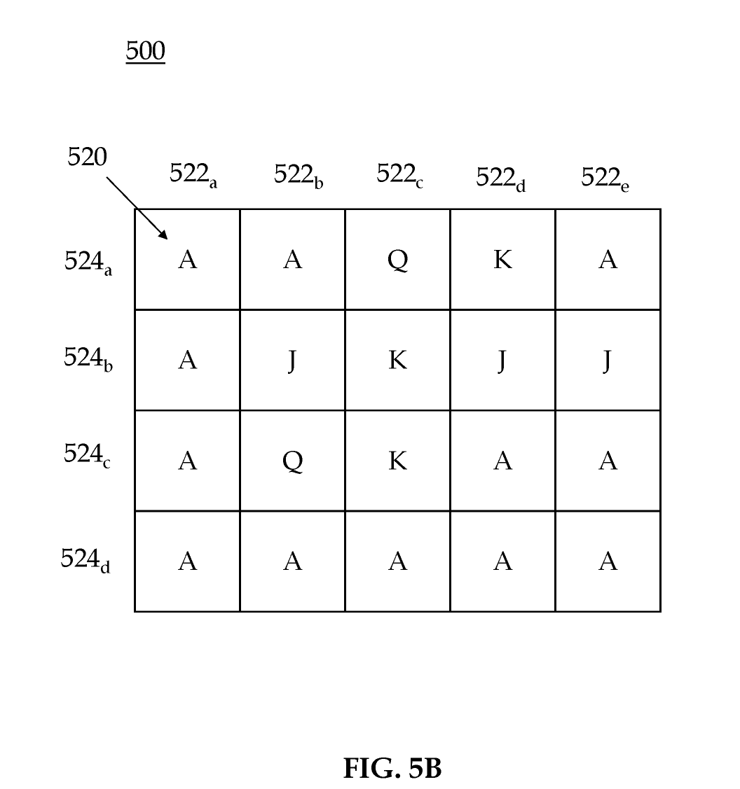

An example game showing symbol replacement in accordance with exemplary embodiments of the present disclosure is depicted in FIGS. 5A and 5B.

Referring now to FIGS. 5A and 5B an exemplary display of a gaming device showing a visible play matrix 500 is shown, in accordance with one embodiment of the present invention. As shown, a plurality of reels, such as reels 522a, 522b, 522c, 522d and 522e, are provided. Each of the reels 522 includes at least one, and often a plurality, of symbol positions 526. For ease, only one symbol position 526 is shown with a reference number, however a plurality of symbol positions 526 may exist on each reel 522a, 522b, 522c, 522d and 522e. The visible play matrix consists of a portion of the reels 522a, 522b, 522c, 522d, and 522e. The intersection of these reels with rows 524a, 524b, 524c, and 524d, or the like may create the visible symbol positions. Symbol positions may be the positions or areas on the reels where symbols 520 are located and displayed to a player. For example, symbol position (3/2) refers to the third reel (i.e., reel 522c) and the second position (i.e., row 524b). In the example depicted in FIG. 5A, position 3/2 includes the “K” symbol. The number of reels and symbol positions depicted in the figures are merely examples, and other numbers of reels and/or symbol positions suitable for embodiments of the present disclosure are contemplated.

In this exemplary embodiment, the reels 522 include a plurality of symbols 520 which are the letters A, Q, K, J, and R1. In this example, A, Q, K, and J are standard symbols or static symbols and R1 indicates a reserved symbol designated for substitution. It should be appreciated that the reels may include any suitable symbols, characters or images as desired by the game designer. In one embodiment, each of the symbol positions on the reels includes a predetermined or designated symbol from the plurality of symbols. In another embodiment, each of the symbol positions on the reels includes a randomly determined symbol from the plurality of symbols, based on an algorithmic formula and distribution of symbols. It should be appreciated that any of the symbols may be in any of the symbol positions on the reels.

In the example depicted in FIG. 5A, symbol “R1” is designated to indicate the reserved symbols in reel 1 (i.e., column 522ₐ). In some embodiments, the reserved symbols may be in fixed positions on the reels, may be selected randomly by a processor, may comprise the entire reel, or the like. Any suitable combination of consecutive replacement symbol locations or non-consecutive replacement symbol locations is contemplated by and within embodiments of the present disclosure. In instances where there are consecutive replacement symbols, the game rules can similarly indicate that there is a modification at that location and store the number of consecutive symbols at that location. When the game is played, the reserved symbols are replaced and/or populated according to a schema, which may be randomly selected by the game. In the example depicted in FIG. 5A, the symbols in position 1/1, 1/2, and 1/4 (i.e., column 522ₐ, rows 524ₐ, 524_{b}, and 524_{d}) are designated as replacement symbols. It is contemplated that a reel may comprise any number of suitable symbol locations, and is not limited to the 4 symbol locations depicted in FIG. 5A.

In some exemplary embodiments, a selected replacement schema replaces all reserved symbols on a reel regardless of whether the symbols land in the visible play matrix. In these embodiments, the player sees the symbols on each of the reels scroll on and off the visible screen before the reels stop scrolling and display the resulting visible play matrix. In some exemplary embodiments, the player is shown long stacks of identical symbols as the reels scroll thus creating greater anticipation for a large win. In some other embodiments, players may be shown the modification.

In operation, the reserved symbols R1, R2, R3, etc., may be replaced when a schema is selected. As an example, referring to FIG. 4, one of the schemas 414 in the weighted table 400 may be selected and the likelihood of a particular schema 414 being selected may be determined by an associated probability or weight (i.e., column 416). The likelihood a particular schema may be selected may generally be determined by the likely prize amount for that particular schema. For example, a schema of 1, 1, 1, 1, 1 may result in identical symbols populating replacement locations in each of the reels, thereby increasing the players chance of winning a large prize. In contrast, a schema of 0, 1, 2, 3, 0, 1 may be less likely to produce a large prize. In this example, the schema more likely to produce a large prize may be assigned lower probability of selection than the schema less likely to produce a large prize. Suitable probabilities or weights may be assigned to each schema by the game designer in accordance with gaming regulations, or the like.

For purposes of illustration, in one example the game may select schema 414_{b} in the table 400 shown in FIG. 4. Schema 414_{b} shows replacement indicators 1, 2, 1, 2, 2. In the example shown in FIG. 5A, the reserved symbols are limited to column 1 (i.e. 522ₐ), as indicated by symbol “R1”. Accordingly, in every instance of a reserved symbol (i.e., where “R1” appears), those symbols are to be replaced and/or populated with the corresponding replacement symbol. In this example, the first replacement indicator corresponding to the first row is a “1.” To determine what replacement symbol corresponds to the replacement symbol indicator 1, the key, like the one depicted in FIG. 3 may be used.

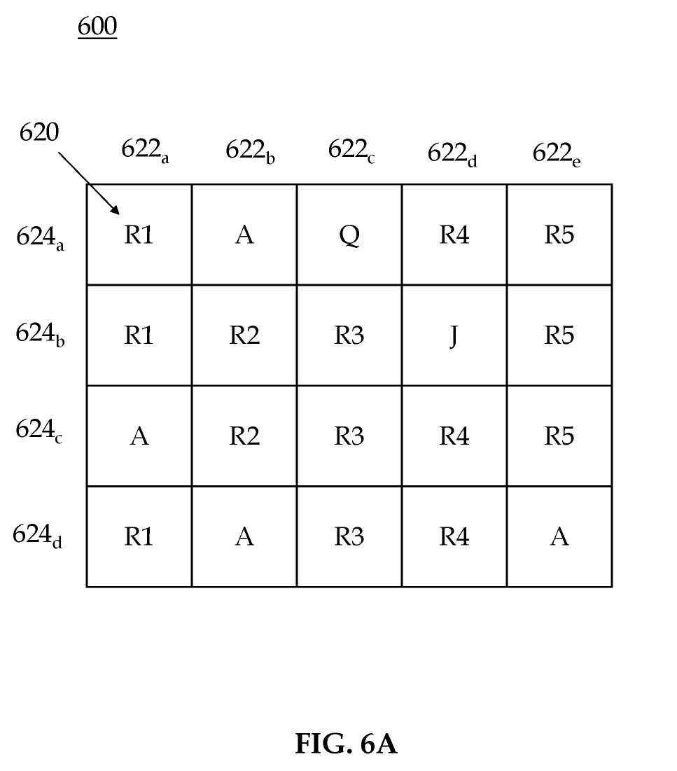

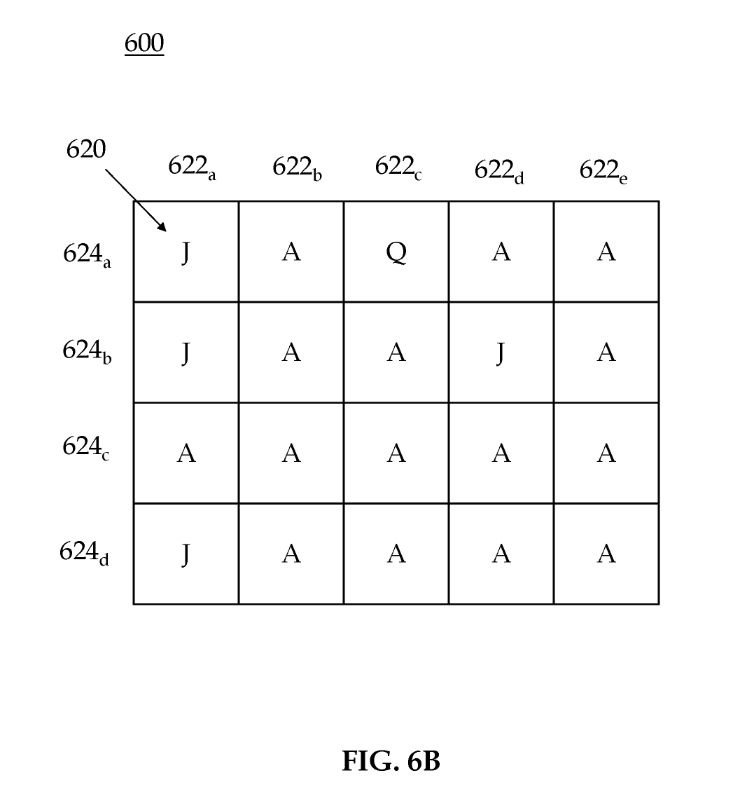

In this example, using the key shown in FIG. 3, the replacement indicator “1” corresponds to replacement symbol “A.” As such, the reserved symbols “R1” in row 1 (i.e. 522ₐ) of the play matrix 500 are replaced and/or populated with the replacement symbol “A.” The resulting display of the play matrix 500 after symbol replacement/population is depicted in FIG. 5B. As can be seen in FIG. 5B, the corresponding reserved symbols indicated by “R1” in FIG. 5A have been replaced and/or populated by the replacement symbol “A,” resulting in the entire first reel being populated by the symbol A. The symbols may be replaced before and/or after the wheels are virtually “spun” and the stop position of each reel is determined. As a result, in this example, row 524_{d} results in a potentially winning payline consisting of symbols A, A, A, A, A, which may result in a prize for the player. This replacement and/or populating of various symbol locations with consecutive symbols may generally have the effect of creating a more interesting and/or exciting game experience for the player. Although the reserved symbols/replacements are depicted only in reel 1 in the example shown in FIGS. 5A and 5B, it is contemplated that every reel may comprise reserved symbols, for example, as shown in the example depicted in FIGS. 6A and 6B.

FIGS. 6A and 6B depict a game display illustrating an example of one embodiment of the present disclosure wherein symbols may be replaced on more than one reel in play matrix 600. Similar to the example discussed with respect to FIGS. 5A and 5B, the display comprises reels 622ₐ, 622_{b}, 622_{c}, 622_{d}, and 622ₑ with a number of symbol locations 620 suitable for embodiments of the present disclosure. In addition to the reserved symbol indicated by symbol “R1” in reel 1 (i.e., 622ₐ), the example depicted in FIG. 6A shows reserved symbols across more than one reel, as indicated by symbol “R2” in reel 2 (i.e., 622b), symbol “R3” in reel 3 (i.e., 6220, symbol “R4” in reel 4 (i.e., 622a), and symbol “R5” in reel 5 (i.e., 622ₑ).

Although reserved symbols are present in each and every reel in the example shown in FIGS. 6A and 6B, any number of reels with reserved symbols suitable for embodiments of the present disclosure is contemplated. For example, 1, 2, 3, 4, or 5 reels may include reserved symbols. The reels containing reserved symbols may be consecutive, for example reels 1, 2, and 3 or non-consecutive, for example, reels 1 and 5, or the like. Any suitable combination of reels that include reserved symbols and reels that do not include reserved symbols are contemplated. In some embodiments, the number of reels containing reserved symbols and the location of the reels containing reserved symbols may be preselected by an administrator, selected randomly, or selected via a weighted table, or the like.

In operation, the symbol locations 620 containing replacement symbols R1, R2, R3, R4, and R5 shown in FIG. 6A will be replaced by replacement symbols according to a selected schema and key in accordance with exemplary embodiments of the present disclosure when the game is played. For example, referring to FIG. 4, schema 414_{b} may be selected. Schema 414_{c} indicates the replacement indicators 2, 1, 1, 1, 1 are to be used in replacing/populating the replacement symbol locations (i.e., R1, R2, R3, R4, and R5).

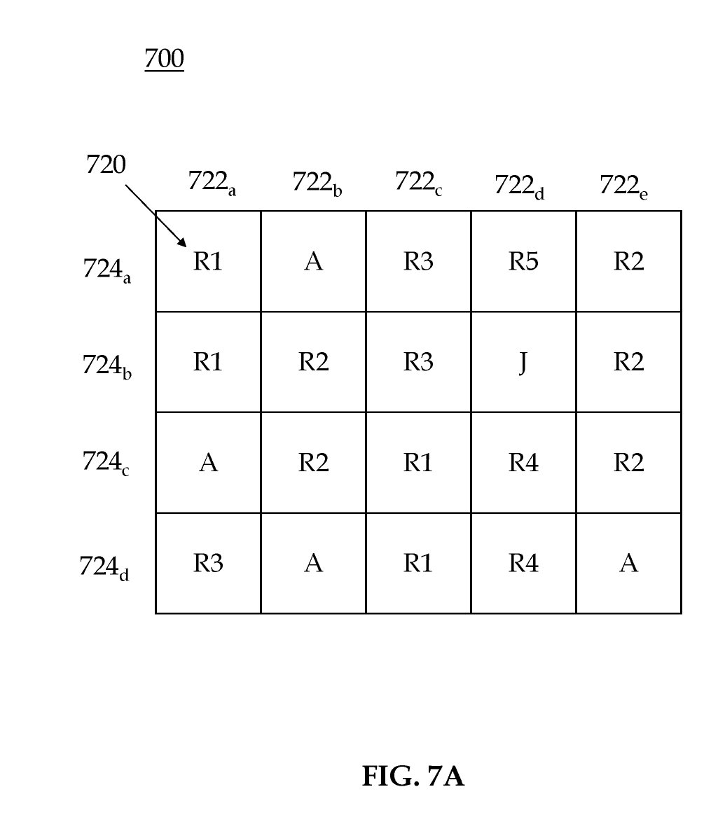

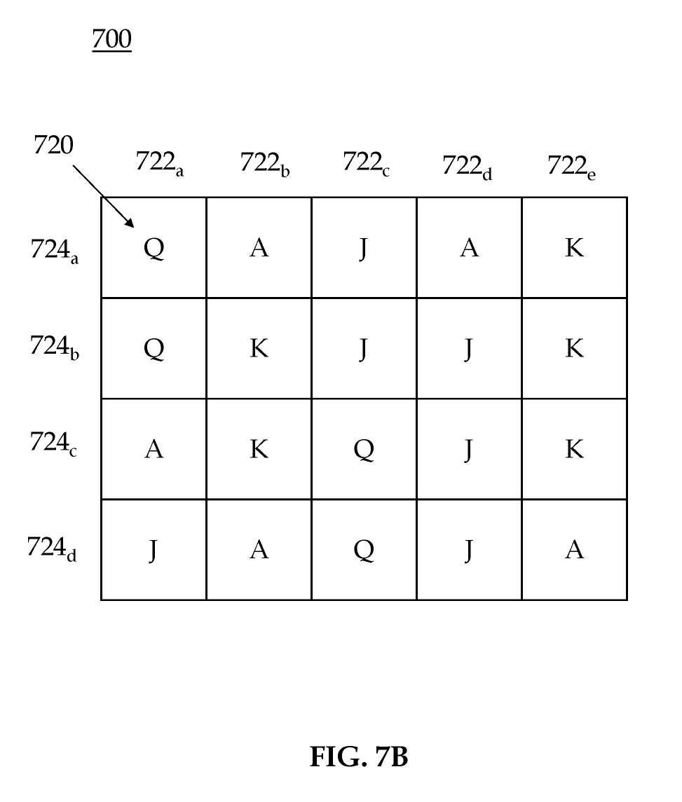

In this example, according to the exemplary key depicted in FIG. 3, replacement indicators 2, 1, 1, 1, 1 correspond to symbols J, A, A, A, A, respectively. As such, by way of example, reserved symbols in reel 1 where R1 appears in the play matrix depicted in FIG. 6A will be replaced/populated with a “J” symbol and the remaining reserved symbols in reels 2-5 will be replaced with the symbol “A.” FIG. 6B depicts the results of this exemplary replacement/population of the replacement symbol locations R1-R5. Again, as in all examples presented herein, the symbols may be replaced before and/or after the reel is virtually “spun” and the stop positions of each reel, along with the symbols in the visible play area of the game, are determined. In this example, row 624_{c} includes symbols A, A, A, A, A, which could potentially represent a win for the player, or the like. In some embodiments, the reserved symbols (e.g. R1-R5) may be disbursed randomly throughout the play matrix. For example, the “R1” reserved symbol may not necessarily be located exclusively in reel 1, and so on. FIG. 7A depicts an example of this embodiment.

FIGS. 7A and 7B depict a game display illustrating an example of one embodiment of the present disclosure wherein symbols are replaced on more than one reel and the reserved symbols are distributed through the play matrix. As with the other examples, a set of reels in a matrix 700 are displayed. The reels 722ₐ, 722_{b}, 722_{c}, 722_{d}, 722ₑ may contain different reserved symbols R1-R5. As in other games the rows 724ₐ, 724_{b}, 724_{c}, 724_{d} may designate one or more paylines, generally dependent on the wager of the player. The matrix 700 also comprises a plurality of symbol locations 720. In some embodiments, the reserved symbols R1-R5 may be randomly distributed on one or more reels and/or may be distributed in accordance with a weighted table, or the like.

In the example depicted in FIG. 7A, the reserved symbols R1-R5 may be spread out on various reels throughout the play matrix. In some embodiments, the reserved symbols may be placed after being selected via a weighted table, or the like. In this example, reel 1 (i.e., 722ₐ) includes both reserved symbol R1 and R3, reel 2 (i.e., 722_{b}) includes just reserved symbol R2, reel 3 (i.e., 7220 includes both reserve symbols R1 and R3, reel 4 (i.e., 722a) includes both reserved symbols R4 and R5, reel 5 (i.e., 722ₑ) includes reserved symbol R2. When the game is played, the reserved symbols R1-R5 may be replaced according to a weighted table of schemas, for example, the weighted table depicted in FIG. 4, or the like.

To replace/populate the reserved symbols with replacement symbols, a schema may be selected. In the example depicted in FIGS. 7A and 7B, schema 414ₐ, comprising replacement indicators 0, 3, 2, 2, 1 is selected. According to the example replacement key depicted in FIG. 3, the replacement indicators 0, 3, 2, 2, 1 correspond to replacement symbols Q, K, J, J, A. As such, the reserved symbols R1, R2, R3, R4, and R5 on the matrix depicted in FIG. 7A would be replaced with Q, K, J, J, and A respectively. The resulting matrix is depicted in FIG. 7B, wherein the replacement symbols Q, K, J, J, and A replace/populate reserved symbols R1, R2, R3, R4, and R5, respectively. While a symbol key with a single replacement indicator corresponding to a single replacement symbol may be used, it is appreciated that a symbol key with multiple replacement indicators and/or replacement symbols may be included on the same row. An example of a symbol key with two replacement symbols corresponding to a single replacement indicator is depicted in FIG. 8.

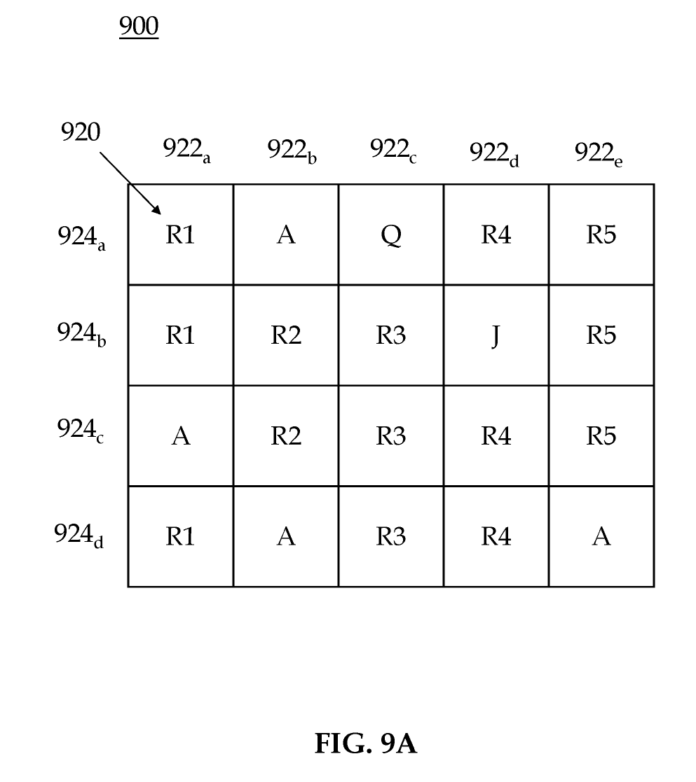

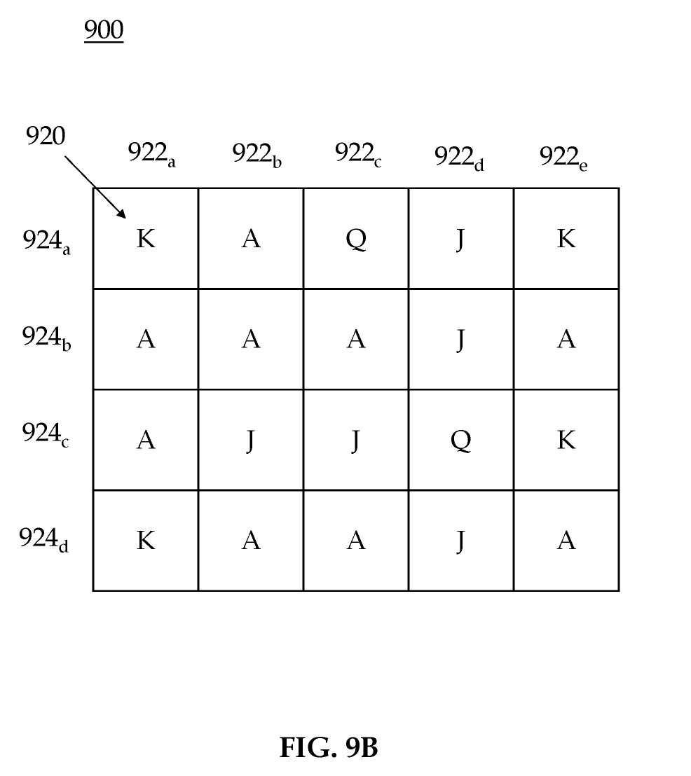

FIG. 8 depicts a symbol key 800 for use in connection with a symbol replacement schema with alternating replacement symbols 810, 812 in accordance with embodiments of the present invention. The key 800 may generally comprise a first column 802 comprising replacement indicators 808 and additional columns 804, 806 containing replacement symbols 810, 812 corresponding to the replacement indicator 808 in the same row 814. The key 800 may comprise rows 814 that indicate a correlation to a replacement indicator 808 that correspond to one or more replacement symbols 810, 812. Although two replacement symbols 810, 812 corresponding to a single replacement indicator 808 are depicted in FIG. 8, it is contemplated that any number of suitable replacement symbols 804, 806, may correspond to a single replacement indicator 808. For example, 3, 4, 5, or 6 replacement symbols may correspond to a single replacement indicator 808. As such, when a specific schema is selected in accordance with exemplary embodiments, when the replacement symbols used to replace/populate a reserved symbol may alternate with each instance occurring on the play matrix, or the like. An example of the use of a key 800 with more than one replacement symbol 810, 812 corresponding to a single replacement indicator 808 is illustrated in FIGS. 9A and 9B.

FIGS. 9A and 9B depict a matrix 900 illustrating an example of one embodiment of the present disclosure wherein symbols are replaced on more than one reel and the replacement symbols are alternated. As with many embodiments described herein, the game matrix 900 depicted in FIG. 9A may comprise a number of reels 922ₐ₋ₑ, and rows 924_{a-d} forming symbol locations. In this example, a symbol key, such as the symbol key depicted in FIG. 8, may be used in conjunction with a weighted schema table to determine replacement symbols for the reserved symbols R1-R5.

In an exemplary embodiment, replacement symbols may appear on the reels in an alternating pattern. For example, a checkerboard of replacement indicators 1 and 2 would be 1,2,1,2,1,2,1,2,1,2,1,2,1,2, etc. Instead of a single stack of all replacement indicators having the value of “1”, as a replacement symbol on a particular reel, two symbols may alternate in a single reel or stack (i.e. in a checkerboard formation). Aside from being visually pleasing, checkerboard patterns landing on adjacent reels could be used to provide the player a special reward (for example, a multiplier). Oversized animations involving both symbols involved in the checkerboard can also be introduced.

For example, referring to FIG. 4, schema 414a may be selected. Schema 414a may include the replacement indicators 3, 1, 1, 2, 3. In this example, using the symbol key depicted in FIG. 8, the reserved symbols R1 and R5 will be replaced/populated with alternating symbols K and A that are associated with replacement indicator 3; the reserved symbols R2 and R3 will be replaced/populated with alternating symbols A and J that are associated with replacement indicator 1; the reserved symbol R4 will be replaced/populated with alternating symbols J and Q, or the like.

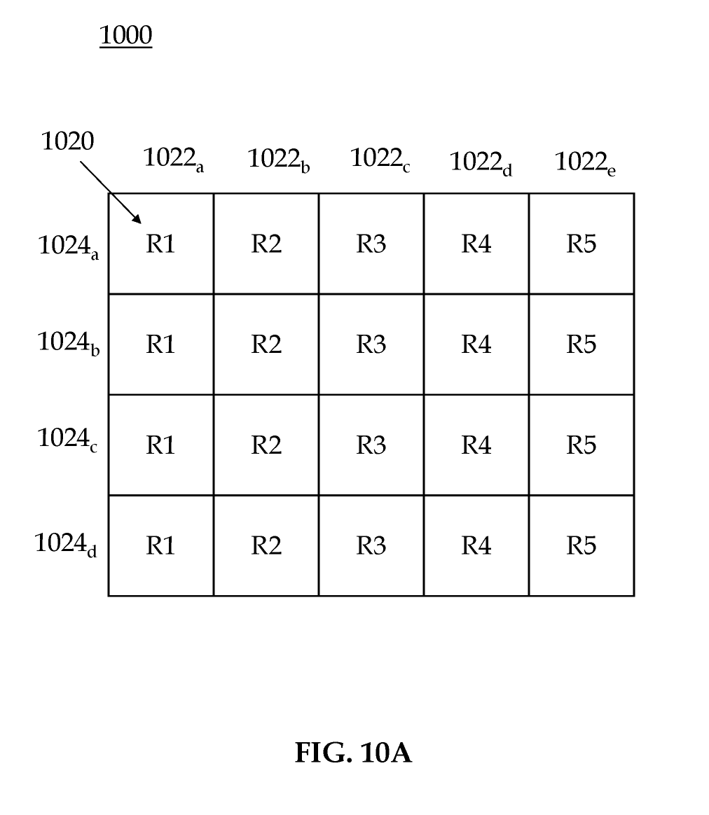

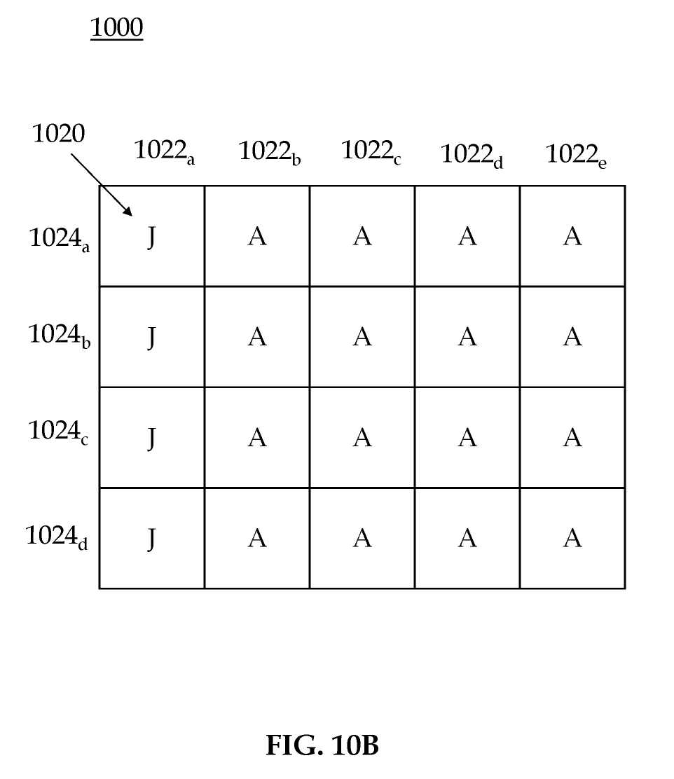

FIG. 9B illustrates the replacement/population of the reserved symbols R1-R5 in an alternating manner in accordance with exemplary embodiments. In many embodiments of the present disclosure, static symbols or symbol locations that are not replaced and/or populated when the game is played may be present. In some embodiments, all symbol locations are designated as reserved symbols so that every symbol is evaluated for replacement. FIGS. 10A and 10B illustrate an example wherein all symbols are designated as reserved symbols.

FIGS. 10A and 10B depict a game matrix 1000, illustrating an example of one embodiment of the present disclosure wherein all symbols are replaced on all reels. The matrix 1000 may comprise reels 1022ₐ₋ₑ and rows 1024_{a-d} that form a matrix of symbol locations 1020. The symbol locations 1020 may all comprise reserved symbols, indicated by the symbols R1-R5 in FIG. 10A. The reserved symbols may be replaced/populated according to a schema selected by methods in accordance with embodiments of the present disclosure. Although in FIG. 10A the reserved symbols R1-R5 correspond to the reel they are disposed in (i.e., “R1” is located in reel 1 1022ₐ; “R2” is located in reel 2 1022_{b}; and the like) it is contemplated that the reserved symbols R1-R5 may be dispersed in any suitable locations or pattern in accordance with exemplary embodiments.

In the example depicted in FIGS. 10A and 10B, schema 414c is selected. Schema 414c depicted in FIG. 4 corresponds to the replacement indicators 2, 1, 1, 1, 1. In accordance with the example symbol table shown in FIG. 3, replacement indicators 2, 1, 1, 1, 1 correspond with replacement symbols J, A, A, A, A. In this example, when the game is played reserved symbols R1, R2, R3, R4, and R5 are then replaced/populated by symbols J, A, A, A, A, respectively. The resulting matrix is depicted in FIG. 10B.

This embodiment varies from some of the other embodiments described herein in that in some of the embodiments described herein, some of the symbols appear stacked on the reels and there are instances of single symbols (unstacked symbols) appearing on the reels. In this embodiment, there are no unstacked symbols and on each reel all symbols are stacked (i.e., identical symbols are located on the same reel on adjacent spaces to each other) and unstacked symbols will never occur. This feature may volatize the game, removing the small undesirable wins, and allowing more money to be placed in exciting wins, or the like.

In some embodiments, a prize may be issued to the player when collections of full stacks in direct contact with one another. In the example depicted in FIG. 10A, four full stacks populated with the “A” symbol 1022_{b}, 1022_{c}, 1022_{d}, 1022ₑ are disposed adjacent and in direct contact to each other. As such, in some embodiments, this may generate a prize. In some embodiments, to generate a prize, a predetermined combination of stacks of symbols in direct contact with each other may trigger a prize. For example, a stack of “A” symbols and a stack of “K” symbols on adjacent or touching reels may trigger a prize if the game is configured accordingly. In accordance with this embodiment, the player can focus her/his attention on the getting boxes (e.g., adjacent reels containing stacks of identical symbols).

In another embodiment of the present disclosure, a payout may be based the number of “stacks” (e.g., consecutive identical symbols on a portion of a reel) in a resulting matrix. In this embodiment, a player may receive a credit award when more than two stacks of the same symbol land fully on the screen, even when the stacks are not immediately adjacent or in direct contact with each other. In the example shown in FIG. 10A, 4 stacks of the same symbol “A” have landed on the screen and, as such, a prize may be awarded to the player. In some embodiments, there may be a scatter award for two or more of the same of kind symbol, or a predetermined set of winning symbols, filling up an entire reel/column on the viewable matrix, even if the reel/columns are not adjacent to each other, but simply displayed in the viewable matrix. In some embodiments, the more columns of the same symbol that are present in the viewable matrix, the higher the award.

In another embodiment of the present disclosure, stacks of different symbols occurring at least once may trigger an event, such as a bonus round, an automatic win, a re-spin event, or the like. For example, a stack of a symbol on the first reel together with a stack of the same or a different symbol on the second reel may trigger a re-spin event. This feature may be used as a way to trigger interesting events in a game and may be visually appealing due to the stacks. This may be used as a way to trigger a variety of game events in numerous games, or the like.

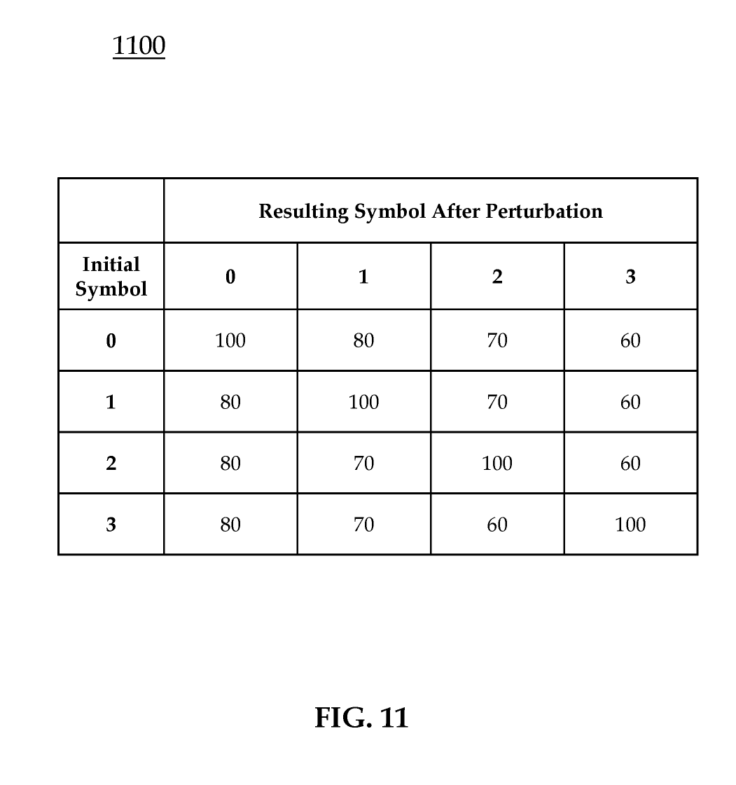

FIG. 11 depicts an example of a weighted table of perturbations 1100 for use with embodiments of the present invention. In some embodiments, after a replacement indicator, or a schema of replacement indicators is selected, a perturbation or “perturb” may be run, which may keep the symbol the same or change the symbol based on a weighted table of perturbations, such as the example table 1100 shown in FIG. 11. In the example shown in FIG. 11, the initial symbol, or replacement indicator, is shown in the first column and the probability or weight of selecting a particular resulting symbol or replacement indicator is indicated by the columns.

For example, according to the example chart shown in FIG. 11, if an initial symbol or replacement indicator is 0, then after the perturb is run, the highest probability of the resulting symbol, with a weight of 100, is keeping the symbol the same 0. The second highest probability of a resulting symbol after running a perturb, with a weight of 80, is changing the symbol or replacement indicator to 1. The third highest probability of a resulting symbol after running a perturb, with a weight of 70, is changing the symbol or replacement indicator from 0 to 2. Lastly, in this example, the fourth and least likely scenario, with a weight of 60, is changing the symbol or replacement indicator from 0 to 3 after the perturb, or the like. This table and the symbols shown are merely an example and are included for ease of explanation. It is contemplated that any suitable number of columns, rows, symbols, replacement indicators, resulting symbols or replacement indicators, and weights in accordance with embodiments of the present disclosure may be used.

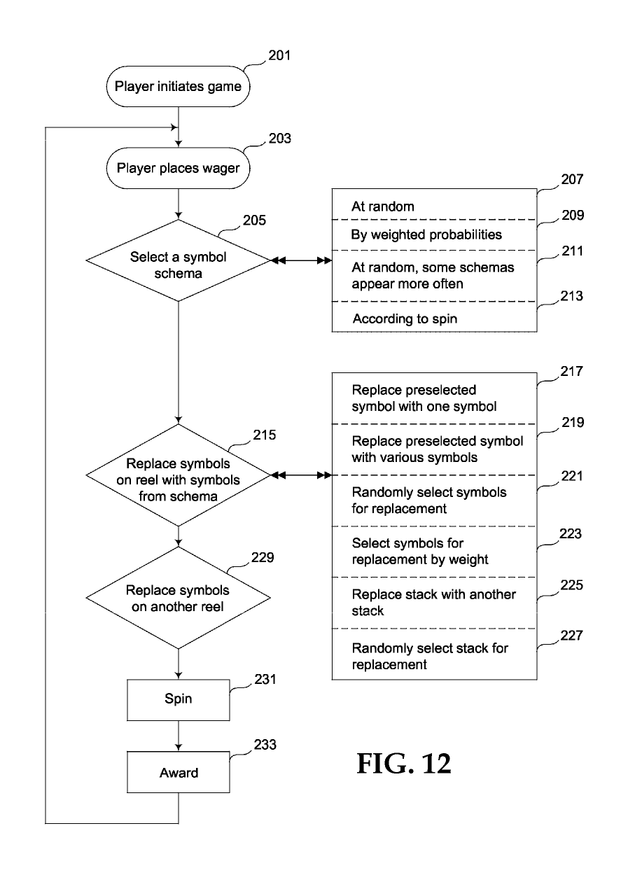

FIG. 12 depicts a flow chart illustrating an example method in accordance with embodiments of the present disclosure. The flow chart depicted in FIG. 12 shows the operation of various features of some of the embodiments as described above. In exemplary embodiments, a player may cause a game to commence 201 and place a wager 203. In some slot machines, or the like, these two actions may be combined into a single action, for example, the player may initiate the play by placing a wager, for example by depositing a coin, or the like. A symbol schema may be selected 205 by a processor, or the like. This may be done by random selection 207, for example, by weighted probabilities, where some schemas may be weighted toward a more likely selection than others 209, or at random but where some schemas may be listed more than once and therefore are more likely of selection 211. In addition to the foregoing, a schema may be selected according to a count of recent plays 213. For example, a schema may be selected for 70% of the spins and the original symbols may be used for the other 30%.

Where a schema has been selected, symbols on a reel may be replaced or inserted according to the schema 215. For example, a preselected symbol may be removed whenever it appears on the reel and replaced with one symbol prescribed by the schema 217 or with various symbols prescribed by the schema 219. Symbols may be randomly selected for replacement 221, or the like. Symbols may be selected by a weighted procedure 223. A stack of symbols may be replaced with a stack of different symbols once per reel, or every time the stack appears on the reel 225, or a stack may be randomly selected for replacement 227.

In some embodiments, symbols on one or more other reels may also be replaced 229. When all replacing of symbols has been completed, the reels may be spun mechanically or in video depiction 213. If a winning combination of symbols appears in a pay line, an award is given 233, for example, in the form of a cash payout or in the form of credits that can be used for future games or exchanged for cash at the player's option. The play may repeat at the player's option. Various embodiments and features have been described, but the invention is not to be limited by any of these embodiments or variations or by anything in the drawings or the forgoing description.

It should be emphasized that the above-described embodiments of the present invention are merely possible examples of implementations, merely set forth for a clear understanding of the principles of the invention. Many variations and modifications may be made to the above-described embodiment(s) of the invention without departing substantially from the spirit and principles of the invention. For example, an element disclosed by one embodiment of the present invention may be included in any other disclosed embodiment, where suitable. All such modifications and variations are intended to be included herein within the scope of this disclosure and the present invention.

1. A gaming system for play of a game, comprising:
a display having a display area for play of a game;
a credit acceptor to enable input of credit for wagering on the play of the game; and a game controller, said game controller comprising:
a first set of symbols, each symbol having a predefined location in said first set relative to others of said symbols; and
a second set of symbols; and wherein the game controller is configured to incorporate the second set of symbols prescribed by a schema into the first set by adding the predefined number of said second set of symbols prescribed by the schema into the first set relative to a selected location in said first set so as to define a modified symbol set, to select from the modified symbol set a plurality of symbols for a game outcome, to display in the display area symbols from the modified symbol set for play of the game, and to display a game outcome based on the selected symbols from the modified symbol set.

2. A gaming system as claimed in claim 1, wherein the symbols prescribed by the schema of the second set of symbols are randomly determined.

3. A gaming system as claimed in claim 1, wherein the symbols prescribed by the schema of the second set of symbols are determined according to at least one game condition.

4. A gaming system as claimed in claim 1, wherein the symbols prescribed by the schema of the second set of symbols are determined according to a wager amount.

5. A gaming system as claimed in claim 1, wherein the second set of symbols includes a plurality of different symbol types.

6. A gaming system as claimed in claim 1, wherein the second set of symbols includes a plurality of symbol groups, each symbol group being associated with a symbol reel, and each symbol group including at least one of the same symbol.

7. A gaming system as claimed in claim 6, wherein at least one symbol group includes a plurality of a first symbol type, and at least one other symbol group includes a plurality of a second symbol type.

8. A gaming system as claimed in claim 6, wherein at least some symbol groups include differing numbers of symbols.

9. A gaming system as claimed in claim 1, wherein the second set of symbols includes a plurality of symbol groups; and wherein the symbols prescribed by the schema in the second set of symbols are defined according to desired conditional probability chains between symbol groups that produce desired win probability outcomes.

10. A gaming system as claimed in claim 1, wherein the system is arranged to incorporate the symbols prescribed by the schema into the first set of symbols by symbols prescribed by the schema of the at least one set of symbols to the first set of symbols.

11. A gaming system as claimed in claim 10, wherein each symbol added to the first set of symbols is disposed between two symbols in the first set of symbols.

12. A gaming system as claimed in claim 1, wherein the schema comprises a symbol pattern defining the intended location of symbols relative to the symbols in the first set of symbols.

13. A gaming system as claimed in claim 12, wherein the system comprises a third set of symbols, each said second set and said third set configured of symbols, said second set comprising a different symbol pattern than said third set, and wherein the game controller is configured to select at least one of the second set and third set of symbols to be incorporated into the first set of symbols.

14. A gaming system as claimed in claim 13, wherein second and third sets of symbols correspond to different win outcome probabilities.

15. A gaming system as claimed in claim 13, wherein the game controller is configured to randomly select one of said second and third sets of symbols.

16. A gaming system as claimed in claim 13, wherein the game controller is configured to select one of said second and third sets of symbols using a weighted table.

17. A gaming system as claimed in claim 16, wherein the gaming system includes a plurality of weighted tables; and wherein the game controller is configured to select a first weighted table to use to select on of said second and said third sets of symbols.

18. A gaming system as claimed in claim 17, wherein a plurality of games are implemented by the gaming system; and wherein the game controller is configured to select a first weighted table to use for a first game, and to select at least one different weighted table for use in a subsequent game.

19. A gaming system as claimed in claim 1, wherein the game controller is configured to implement a base game using the first set of symbols, and to implement a feature game wherein the symbols prescribed by the schema from the second set of symbols are incorporated into the first set of symbols so as to define a modified symbol set; and wherein the game controller is configured to select and display a plurality of symbols from the modified symbol set.

20. A method of gaming using a display having a display area, a credit input mechanism to enable input of credit for wagering on play of a game, a game controller having a first set of symbols and a second set of symbols, comprising:
arranging said symbols in said first set of symbols to associate each said symbol with a predefined location in said first set of symbols;
defining a predetermined number of said symbols of the second set of symbols;
incorporating the symbols of the second set into the first set of symbols so as to define a modified symbol set, said incorporating including adding the additional symbols relative to a selected location in the first set of symbols;
selecting from the modified symbol set a plurality of symbols for a game outcome;
displaying in the display area symbols from the modified symbol set for play of the game; and
displaying the game outcome based on the selected symbols from the modified symbol set.
